(19) United States
(12) Patent Application Publication
(10) Pub. No.: US 2002/0184363 A1
(43) Pub. Date: Dec. 5, 2002

(54) Techniques for server-controlled measurement of client-side performance

(76) Inventors: Steven Viavant, Piedmont, CA (US); Arsalan Farooq, San Francisco, CA (US); Jaydeep Marfatia, Santa Clara, CA (US); Manu Shukla, San Mateo, CA (US)

Correspondence Address: HICKMAN PALERMO TRUONG & BECKER, LLP, 1600 WILLOW STREET, SAN JOSE, CA, 95125, US

(21) Appl. No.: 09/945,160

(22) Filed: Aug. 31, 2001

Related U.S. Application Data
(60) Provisional application No. 60/285,577, filed on Apr. 20, 2001.

(51) Int. Cl. G06F 15/173; G06F 15/16

(52) U.S. Cl. 709/224; 709/246

(57) ABSTRACT

Techniques for measuring client-side performance include intercepting an item that is to be sent to a client process prior to the arrival of the item at the client process. The item is modified to produce a modified item that includes code. The code causes a processor on the client device to measure performance related to a service associated with the item. The code also causes the processor to perform one or more acts based on a measurement resulting from measuring performance. The modified item is sent to the client process.

These techniques allow a service provider to automatically modify an item each time the item is sent to a client process, dispelling cumbersome steps in installing and maintaining software on a client device. The modifications may be made transparent to a designer of the server application and thus easily applied to both new and existing server applications. These techniques also allow the service provider to obtain measurements of actual performance experienced by the real users and without placing a spurious load on the website. The code in the modified item can be tailored to provide any response desired, from reporting those measurements to the service provider for analysis by the service provider, to automatically notifying the user of the client process, to automatically diagnosing the cause of unfavorable performance such as by correlating performance problems with particular components of the client process.

### CLAIM OF PRIORITY

This application claims priority to U.S. provisional application serial No. 60/285,577, filed Apr. 20, 2001, entitled “Method for Web Client Response-Time Measurement” by Steven Viavant, Arsalan Farooq, Jaydeep Marfatia and Manu Shukla, hereby incorporated by reference in its entirety.

### FIELD OF THE INVENTION

The present invention relates to determining the performance of a web client in obtaining a service from a web server, and in particular to techniques for controlling the measurement of, and response to, the web client performance with respect to the service provided.

### BACKGROUND OF THE INVENTION

Many enterprises expect to use the Internet to reach far-flung agents and customers. The Internet is a public network of computer networks, each with one or more nodes. The Internet uses open, standard protocols for addressing nodes and passing information from one node to another. A user accesses the Internet by logging onto one of the computers on the network, often owned and operated by an Internet Service Provider (ISP). Typically a user establishes a severable link between the user's own computer and the ISP computer. A client application program (a client process) running on the user's computer (client device) interacts with a server application program (a server process) running on a different computer (server device) on the Internet. The client process initiates communication with a request sent to the server device for service from the application program. The application responds by performing some service including sending some content back to the client process.

The World Wide Web (the Web) is a collection of services available over the Internet that are provided by various servers and that can be accessed by a particular client called a Web browser using a hyper-text transfer protocol (HTTP). Using a Web browser, a user can select a service on the Web, identified by its Universal Resource Locator (URL) name, and have that service provided to the user in the form of actions performed by the server and the content returned to the client. The content includes one or more hypertext markup language (HTML) pages. The content returned usually includes textual information and often includes graphical, video and audio elements. Some of the elements in the returned content are associated with links, where each link includes a URL to another resource on the Web. When a user of the browser selects an element associated with a link, the browser sends a request for the service at the included URL. The location on the network associated with a URL is called a website.

The party providing a web-based service is often concerned with the experience of users of the service. It is in the best interest of the service provider for the user's experience with the service to be as favorable as possible. In general, a user has a favorable experience with a web-based service when the service is provided accurately, easily and quickly. The service is provided accurately when the service provided and content returned is what the user expects. The service is provided easily if the user can obtain the desired service and content with few manual operations such as keystrokes and with little thought. The resource is provided quickly if the user does not notice frequent or long pauses between requesting the service and having the content returned indicating the service is performed.

Part of the user's experience is related to the performance of the server application program and the server device. For example, the time consumed between the time the request is received at the server and the time the content is sent from the server is perceived as a delay by the user. This portion of the delay is controlled by the processing performed by the server processes and the processing power of the server device. There may be different delays introduced between a time when the content is sent (such as when a confirmation of an order or refund is sent to the client process) and a time when a service is fully performed (such as when an item is shipped or a when a debit or credit is posted to a credit card account). The performance on the server side can be monitored by the enterprise and corrected if judged to lead to an unfavorable user experience. For example, perceptible delays caused by a high volume of requests can be corrected to keep the delays imperceptibly small by adding server devices or otherwise improving the facilities devoted to the website.

Part of the user's experience is related to the performance of the network and the client process, which are not controlled or easily monitored by the server application or server device. There are delays introduced as both the request and the returned content traverse the network. There are delays introduced as the client device renders the content on a display of the client device. There are other performance factors that are not apparent on the server side. For example, a user may make extra keystrokes and mouse movements in confused attempts to find a desired resource. Such extra efforts by the user are often not predicted by the website designer. The designer's failure to predict such problems may be due in part to the fact that, when the website is tested by the designer, the designer already knows what is available at the website.

The performance perceived on the client side is not readily monitored on the server side and therefore not readily available to the party responsible for the website. Without knowledge of the performance perceived on the client side, the service provider is not able to respond to many problems related to the perceived performance, such as excessive delays and superfluous keystrokes.

One approach for service providers to obtain client-side performance measurements is to estimate the client-side performance based on running a set of agent programs (agents) on computing devices distributed over different locations on the network. To simulate users of browsers, each agent periodically requests one or more services from a website and receives (downloads) one or more HTML pages. The time taken between sending the request and receiving or rendering the returned content on the device running the agent is used as an estimate of the perceived client response time. The distribution of estimated client response times over the set of agents is taken to represent the distribution of actual client response times experienced by the real users.

While suitable for many purposes, the “simulation-agent” approach suffers from several deficiencies. For example, the simulation-agent approach typically measures the response time for only a few of the services at the website; some services are not tested at all. The simulation-agent approach does not measure the response time from the actual locations where the real users are perceiving the performance of the website. The simulation-agent approach does not simulate user confusion and excess cursor movement or excess keystrokes. The simulation-agent approach places a spurious load on the website by the agents that compete with the real users. Thus, the agents themselves contribute to reductions in perceived performance. In addition, the simulation-agent approach places additional traffic on the network to report the estimated client response times to the service provider.

A second approach is to install agents on the client devices. The client-side agents measure the client response times for the pages downloaded by the client processes of the real users. While suitable for many purposes, the client-side agent approach also suffers from several deficiencies. The client-side agent approach involves cumbersome steps for installing and maintaining the agent software on the client device. For example, some agents take the form of a special device driver that maps in the memory of other device drivers and records some activities of those device drivers. In this example, the agent must be maintained to remain compatible as those other device drivers are upgraded or replaced. The client-side agent approach also involves cumbersome steps on the client device to save, find, schedule and send the measured response times over the network to the service provider.

Based on the above, there is a clear need for techniques that allow a service provider that provides a website to measure and respond to client-side performance issues related to the services provided at the website.

### SUMMARY OF THE INVENTION

Techniques for measuring client-side performance include intercepting an item that is to be sent to a client process prior to the arrival of the item at the client process. The item is modified to produce a modified item that includes code. The code causes a processor on the client device to measure performance related to a service associated with the item. The code also causes the processor to perform one or more acts based on a measurement resulting from measuring performance. The modified item is sent to the client process.

According to another aspect of the invention, techniques for responding to client-side performance include intercepting an item produced by an application. A network connects a client device executing a client process to a server device configured to execute the application to provide a service. The item is modified transparently relative to the application to produce a modified item including code. The code causes a processor on the client device to measure performance related to the service provided by the application. Based on a measurement resulting from measuring performance, the code causes the processor to send data indicating the measurement to the server device. The modified item is sent to the client process and the data indicating the measurement is received and stored in a database. Based on the data, it is determined performance has fallen below a threshold. If performance has fallen below the threshold, then a notification message is sent.

According to another aspect of the invention, a computer-readable medium carries data indicating elements for presentation on a display of a device having a processor by a client process executing on the processor. The computer-readable medium also carries a first sequence of instructions executed upon receipt at the device. The computer-readable medium also carries a second sequence of instructions invoked, after arrival of the first sequence of instructions, by the client process. The second sequence of instructions causes the processor to measure performance related to presenting the elements on the display. The second sequence of instructions also causes the processor to perform an act based on a measurement resulting from measuring performance. The first sequence of instructions causes the client process to associate the second sequence of instructions with an element indicated by the data.

These techniques allow a service provider to automatically modify an item each time an item is sent from a web-based service to a client process, dispelling cumbersome steps of installing and maintaining performance-monitoring agents on client devices. In various embodiments of these techniques, the modifications may be made transparent to a designer of the server application and thus easily applied to both new and existing server applications. These techniques also allow the service provider to obtain measurements of actual performance experienced by the real users and without placing a spurious load on the website. The code in the modified content can be tailored to provide any response desired, from reporting those measurements to the service provider for analysis by the service provider, to automatically notifying the user of the client process, to automatically diagnosing the cause of unfavorable performance such as by correlating performance problems with particular components of the client process or client device.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating a server and a client on a network according to an embodiment;

FIG. 2 is a flowchart illustrating a method for controlling the response to client-side performance according to one embodiment;

FIG. 3 is a block diagram illustrating example content produced by a hypothetical application running on the server device;

FIG. 4A is a flowchart illustrating a first event handler included in modified content sent to a client according to an embodiment;

FIG. 4B is a flowchart illustrating a second event handler included in modified content sent to a client according to an embodiment;

FIG. 4C is a flowchart illustrating a third event handler included in modified content sent to a client according to an embodiment;

FIG. 4D is a flowchart illustrating a fourth event handler included in modified content sent to a client according to an embodiment;

FIG. 5A is a first portion of a flowchart illustrating performance measurement code included in modified content sent to a client according to an embodiment;

FIG. 5B is a second portion of a flowchart illustrating performance measurement code included in modified content sent to a client according to an embodiment;

FIG. 6 is a flowchart illustrating a method to perform analysis of client-side performance measurements according to an embodiment; and

FIG. 7 is a block diagram that illustrates a computer system upon which an embodiment of the invention may be implemented.

### DETAILED DESCRIPTION OF THE PREFERRED EMBODIMENT

Techniques for server-controlled measurement of client-side performance are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### OVERVIEW OF STRUCTURAL ELEMENTS

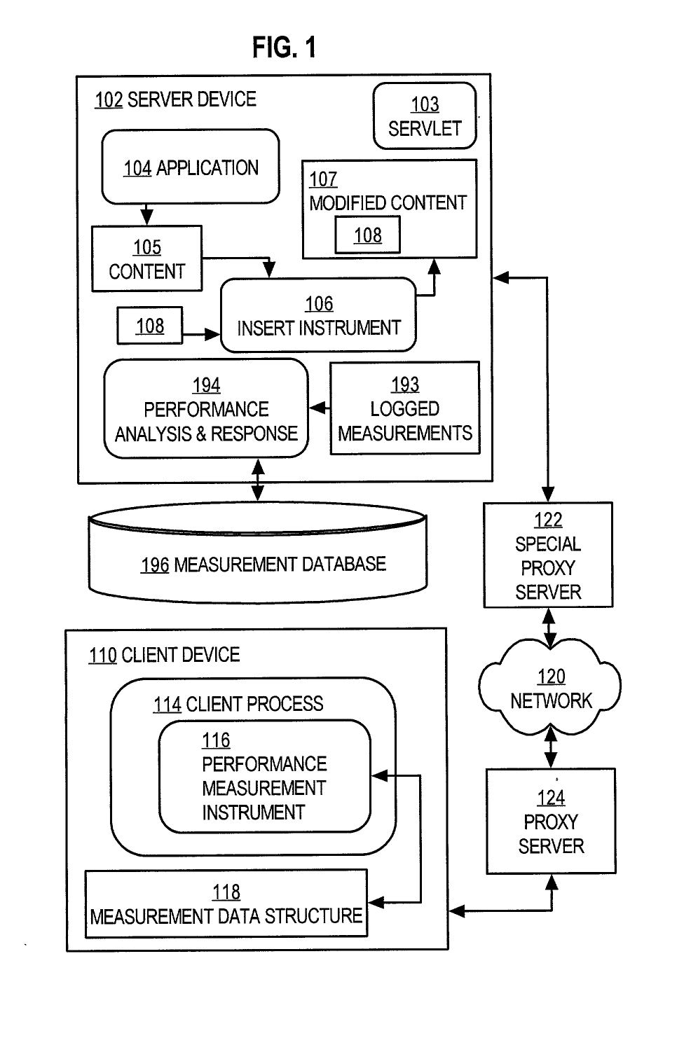

The structural elements and the processes that act on them according to one embodiment of the invention are depicted in FIG. 1. FIG. 1 is a block diagram illustrating a server device 102 of a service provider and a client device 110 connected to a network 120 according to one embodiment. The client device 110 executes a client process 114 which requests a service from an application executing on a server device connected to the network. The server device 102 includes an application 104, which is a process that provides a service over the network in response to a request from a client process. For example, a web server process on the server device 102 routes the request from client process 114 to the application 104 and routes the response to the network. In some embodiments, the web server process includes a servlet 103 for adding particular functionality to the web server.

The client device is connected to the network through a proxy server 124, which provides one or more common services, such as security, for several client devices. In other embodiments, the client device is connected directly to the network 120 without the proxy server 124. As illustrated in FIG. 1, the server device 102 is connected to the network 120 through a special proxy server 122, which provides one or more common services, such as security, for several servers, as described below. In other embodiments, the server device 102 is connected directly to the network without the special proxy server 122.

According to FIG. 1, in response to a request received over the network 120 from the client process 114, the application 104 generates item 105 to send to the client process 114 over the network. Item 105 generally represents any form of content that may be provided over a network. Item 105 may be generated by application 104 in any manner known in the art, such as by retrieving static web pages generated and stored before receiving the client request, or by generating a web page dynamically based on the request and the state of the system at the time of the request. The state of the system includes the current items of a database, the current configuration of hardware, the current time, etc.

After the item 105 has been produced, an insert instrument process 106 intercepts the item 105 before the item 105 reaches the client, and modifies the item 105 to generate modified item 107 based on the original item 105. The insert instrument process 106 is so named because the modifications essentially instrument the item to measure performance on the client side.

According to one embodiment, the modified item 107 includes code which, when received by the client process 114, causes one or more processors on the client device 110 to measure performance related to the service provided by the application 104 and to respond to the measured performance by performing one or more acts based on at least one resulting measurement, as described below.

According to one embodiment, some code 108 is predefined and stored on the server device 102. The insert instrument process 106 modifies the original item by inserting the predefined code 108 so that the modified item 107 includes the predefined code 108. In some embodiments, all the code inserted in the modified item 107 is predefined. In other embodiments, some or none of the code is predefined. In some embodiments involving the World Wide Web, the web server process running on the server device 102 executes the insert instrument process 106. In another embodiment, a servlet 103 of the web server executes the insert instrument process 106. In some embodiments, the item 105, the predefined code 108, the insert instrument process 106 and the modified item 107 reside on the special proxy server 122, as described below.

As shown in FIG. 1, the client process 114 includes a performance measurement instrument 116 as a result of the code in the modified item. The performance measurement instrument 116 is a process that measures some aspect of the client's performance and that acts based on the measurement or measurements.

According to one embodiment, the resulting one or more measurements are stored in a measurement data structure 118 in memory or on a storage device of the client device 110. In other embodiments, the performance measurement instrument 116 executes on the client device 110 as a separate process, outside the client process 114. In some of the other embodiments, the measurement data structure 118 is stored in memory or on a storage device of the proxy server 124.

As shown in FIG. 1, the measurements of client-side performance are returned to the server device 102 and stored in a log 193 of logged measurements. Several methods for logging the measurements on the server are described below. One or more processes 194 to analyze and respond to the measured performance are shown executing on the server device 102. The analysis performed by the processes 194 may include determining trends in performance on one or more client devices. The response may include notifying an application administrator of performance below some pre-established threshold level of performance. As shown in FIG. 1, information based on the logged measurements is stored in a measurement database 196, such as a relational database, to support the analysis and response processes 194. In other embodiments, the logged measurements in log 193, or the analysis and response process 194, or the database 196, or some combination, reside on one or more other devices connected to the network, such as the special proxy server 122, and controlled for the benefit of the service provider providing the application 104.

### FUNCTIONAL OVERVIEW

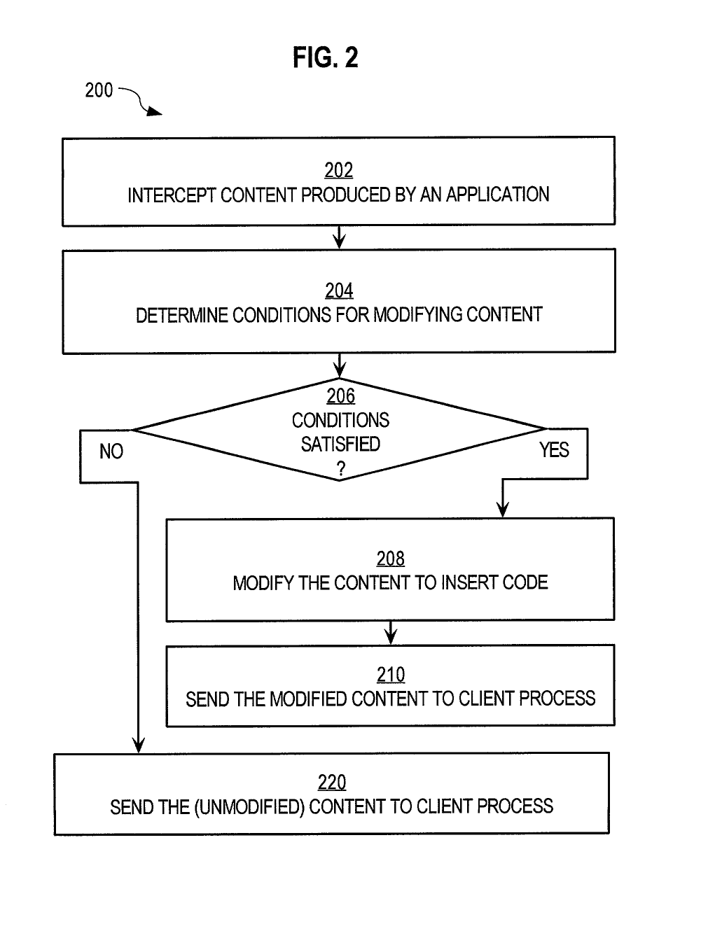

FIG. 2 is a flowchart illustrating a method 200 for controlling the response to client- side performance according to one embodiment. According to one embodiment, the insert instrument process 106 of FIG. 1 performs the steps described in FIG. 2. For example, a web server or a servlet executing the insert instrument process 106 performs the steps of FIG. 2.

In step 202, an item produced by an application is intercepted. In some embodiments, a web server is programmed to intercept the item produced by an application. In other embodiments, a servlet added to a web server intercepts the item. In one embodiment in which web item is cached on the special proxy server 122 before being transmitted over the network, the caching process is modified to perform the modifications to the item.

In a cache-based embodiment, the original item goes from its original source to the cache, and then from the cache to one or more destinations. The modification of the item can take place before the item is stored in the cache, while the item is stored in the cache, or every time the item is sent from the cache to a destination. In one embodiment, the item is cached on the proxy server 124 after being transmitted from an original source but before being transmitted to the client device 110.

### DETERMINING WHETHER TO MODIFY AN INTERCEPTED ITEM

In some embodiments, all intercepted items are modified, and step 204 is not performed. However, it is generally advantageous to perform the modification on only some intercepted items.

In step 204, it is determined whether conditions for modifying an item are satisfied. For example, assume that a website produces an HTML page with references to data for an image, a video stream and an audio stream. The image, video stream and audio stream are sent separately from the web page itself. If the performance of concern is the time for the page to completely load, then the code may be attached to the page and need not be attached to each element of the page that is transmitted separately.

For another example, the service provider may have no interest in the time it takes to load pages that are sent upon occurrence of an error in the application, so the process 106 would determine whether each intercepted item is an error page, and would not instrument the error pages.

For another example, instrumenting only a percentage of the items generated by the application may provide a statistical measure of performance. In this case only one in several items generated by an application would be instrumented. For example, process 106 could be configured to only modify one percent of the items that it intercepts. In such statistical sampling, one factor used to determine whether to modify an intercepted item is a statistical sampling schedule. For example, the number of items generated and sent to one or more clients are counted. The count is compared to a sampling schedule, e.g., every 100^{th} count to sample 1% of the intercepted items. Alternatively, process 106 may be configured to select items to be modified at a certain rate (e.g. one item modified per minute).

In one embodiment, one factor used to determine whether to modify an intercepted item is the type of the item, which may be indicated by the Multipurpose Internet Mail Extension (MIME) associated with the item. The MIME type is identified in a header field that comes before the rest of the data for the item. For example, a Graphic Interchange Format (GIF) image has the MIME type “image/gif” and plain text has the MIME type “text.” In one embodiment, only items of particular MIME types are modified.

In another embodiment, the factors used to determine whether to modify particular items include the names of the items. For example, a web page has a Universal Resource Locator (URL) name used as a reference for finding the page on the web. In one embodiment, only items having page names matching a particular string are modified. Regular string manipulation expressions may be used to specify the match desired. For example, all URLs containing the word “catalog” are specified by the expression “*catalog*.”

In step 206, it is determined whether the conditions for modifying the item are satisfied. For example, it is determined whether the MIME type is “text.” For another example, it is determined whether the URL matches the expression “*catalog*.” For another example, it is determined whether a counter is divisible by 100 with no remainder. If so, control passes to step 208 to modify the item. If not, control passes to step 220 to send the unmodified item to the client process.

In step 208 the item is modified to insert code that causes the client device to measure performance and act on the resulting measurements. Step 208 is described in greater detail in later sections.

In step 210, the modified item is sent to the client process.

In step 220, the unmodified item is sent to the client process.

### EXAMPLE ITEM

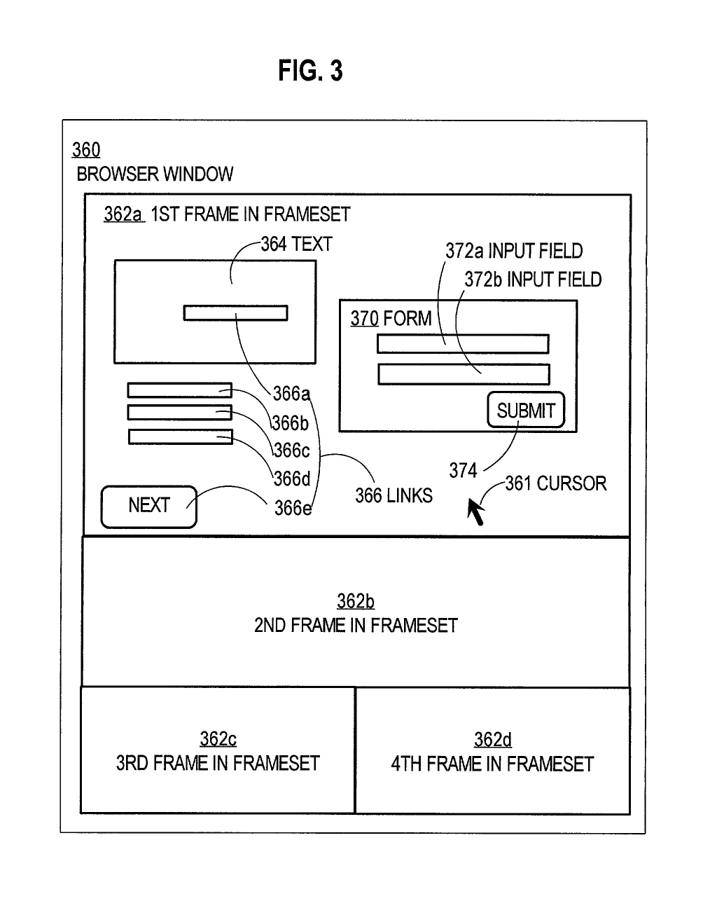

Embodiments of the invention are described below by way of example using the example item depicted in FIG. 3. FIG. 3 is a block diagram illustrating an example item produced by a hypothetical application running on the server device, as the example item appears on the client device. In this example, the item is a frame set of four frames 362a, 362b, 362c, 362d presented by a web browser in a browser window 360 of a display on the client device. The web browser is the client process. Each frame holds one HTML page. The web browser also displays a cursor 361, which indicates a position on the display resulting from the manipulation by a user of the web browser by employing keys or a pointing device, or both, of the client device.

The HTML page in the first frame 362a includes several web page elements, such as a text area 364 and a form 370 where the user may enter data. The first frame also includes several web page elements called links 366. When a user selects a link by positioning the cursor 361 over the link and clicking (e.g., pressing a key on the client device) a request is generated for another web page on the network at a URL address associated with the link in the item delivered to the web browser. The link is often displayed as highlighted descriptive text or a button; the associated URL address in the item is often not presented on the display. For example, link 366a is highlighted text in the text area 364, the links 366b, 366c, 366d are presented as isolated highlighted strings, and link 366e is presented as a button labeled “NEXT.” The other web page at the associated URL is frequently another HTML page generated by the same application that produced the HTML page already displayed.

The form 370 in the first frame 362a includes three web page elements: two input fields 372a, 372b; and a button labeled “SUBMIT.” The user selects one of the input fields 372a, 372b by moving the cursor over one the input field and clicking. The user then enters data into the selected field by pressing keys of the client device. The user may select and enter data repeatedly in the fields until the user is satisfied with the data input. When the user is satisfied, the user moves the cursor over the SUBMIT button and clicks. In response to the clicking on the SUBMIT button the browser sends the data in the input fields 372a, 372b to the application over the network. In response to receiving the data, the application proceeds with the service based on the input, often generating additional HTML pages and framesets.

### EXAMPLE PERFORMANCE

The service provider that provides the example item depicted in FIG. 3 desires that a user of the web browser obtains good performance when interacting with the frameset depicted. In this example, the service provider is interested in two measures of performance. The first measure is the response time perceived by the user between clicking on a link or SUBMIT button and the time the web browser has completed rendering the next frameset in the browser window. The first measure indicates the quickness of the website as perceived by the user. Performance is good by this measure if the response time is imperceptible or less than a very few seconds.

The second measure is the number of movements of the cursor from the time the frameset is rendered by the browser until the time the next link or SUBMIT button is clicked. This measure indicates to some degree how much effort the user expends to complete the user's interaction with the item. In general, the more cursor movements, the greater effort is expended by the user. Performance is good by this measure if the number of cursor movements is small.

In conventional systems, neither the response time perceived by the user, nor the number of cursor movements are readily reported to the server; and, thus neither is readily made available to the service provider.

The example performance information is valuable to the service provider in a variety of ways. For example, where the service provider hosts an application in a network or a virtual private network (VPN), there is often a service level agreement specifying a minimum acceptable performance. If a measure of user perceived response time is available, the service level agreement can be couched in terms of response time for a given number of users, and the service provider can provide service level reports to monitor compliance with the agreement.

The response time measurements also allow the service provider to detect trends of gradually worsening performance, e.g., increasing response times for the same item and client devices, before performance degrades to unacceptable or non-compliant levels.

Furthermore, information on response time correlated with client device allows the service provider to report to the user's organization which client devices have unusual response time problems. For example, if a particular client device, DeviceX, repeatedly shows a response time of 42 seconds for receiving and rendering a particular frameset that most devices operating at the same time receive and render in 7 seconds, then DeviceX probably has a problem. Such a report allows the user's organization to target DeviceX or its network connection, or both, for investigation and possible corrective action.

The response time can also be used for identifying item with pathological rendering problems. The service provider can then target that item for redesign. Similarly, the number of cursor movements can be used for identifying an item with a confusing arrangement that leads to a user excessively moving the cursor back and forth. The service provider can then target that item for redesign.

In concert with ancillary data about the browser type and version associated with the response time, the service provider is able to identify rendering problems that are confined to a particular set of browsers and versions. The service provider can then inform the user's organization of browser upgrades that are suitable to the organization's activities. Also, the service provider can develop a second version of the item, a simpler item that is transmitted and rendered in less response time for the browser versions belonging to the particular set. With two versions of the item, the service provider can adapt its item dynamically, by producing the second version of the item when the browser version detected on the user's device is a member of the particular set.

The response time measurements also allow the service provider to establish procedures for precipitous decreases in performance. For example, in response to a sudden increase in response time, the service provider can cause either the server or client to trigger procedures that shed or redirect network traffic or that notify a system administrator, or cause the server to resort to generating only the simple versions of item that are more easily transmitted or rendered.

The response time measurements also allow the service provider to diagnose and filter metrics of server side performance. A service provider typically gathers a large number of metrics quantifying usage and performance of computational resources on a system of servers supporting a web site. Such metrics may number in the hundreds and include, for example, central processing unit usage, memory usage, disk usage, database-buffer-cache usage, etc., for each of several components. At various times, some of these metrics form spikes, e.g., sharp peaks that pass beyond thresholds of comfortable operation. Not every spike affects the response time perceived by the user. Using response time measurements, correlations can be detected between spikes in server side performance and perceptible response time effects. The service provider can then focus attention and effort on increasing capacity or decreasing use of those components and resources in which spikes most seriously affect the user of the client process.

### EXAMPLE PERFORMANCE INSTRUMENTATION

According to one embodiment of the invention, code is inserted into items produced by an application to measure client side performance and respond to the resulting measurement or measurements. According to one embodiment, the delay between the time a user selects a page, and the time that the page is fully rendered (the “click to eyeball time”) is measured using the following two-step process:

(1) A first set of code is inserted into a first web page. The first set of code is associated with a control, on the first web page, for requesting a second web page. The first set of code is executed when the control is selected. The first set of code records the time at which the control is selected.

(2) A second set of code is inserted into the second web page. The second set of code is executed when the second web page is fully rendered. The second set of code records the time at which the second web page is fully rendered.

The difference between the time recorded by the first set of code, and the time recorded by the second set of code, is the click to eyeball time of the second web page.

In many embodiments, both the first set of code and the second set of code are inserted into each web page generated by the application.

### CLICK TO EYEBALL AND EVENT COUNT MEASUREMENT

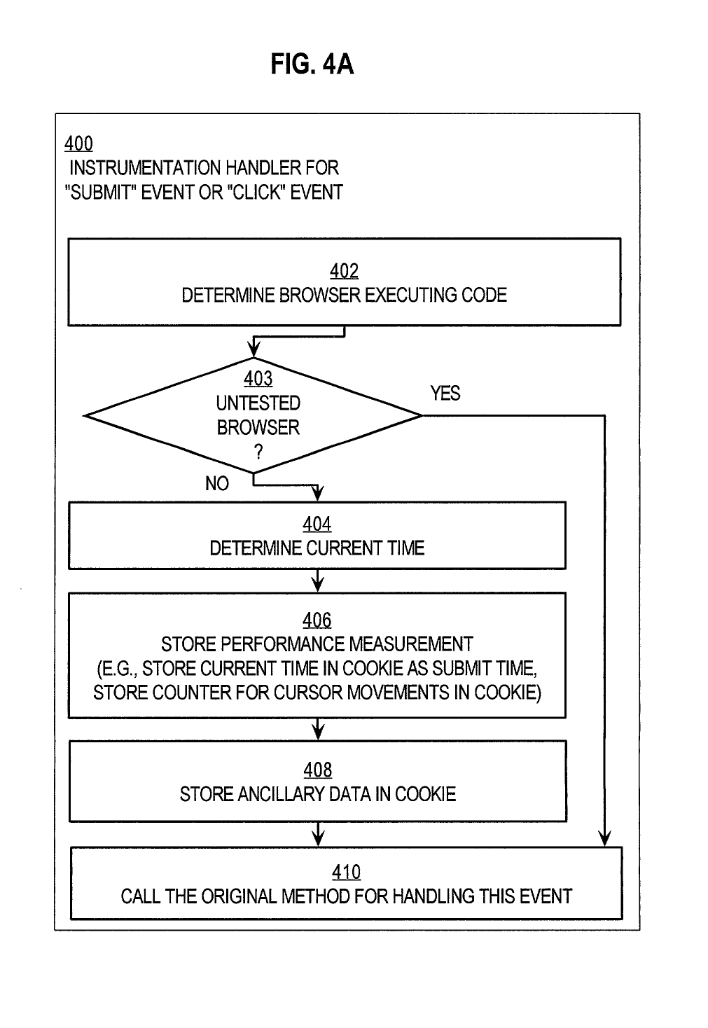

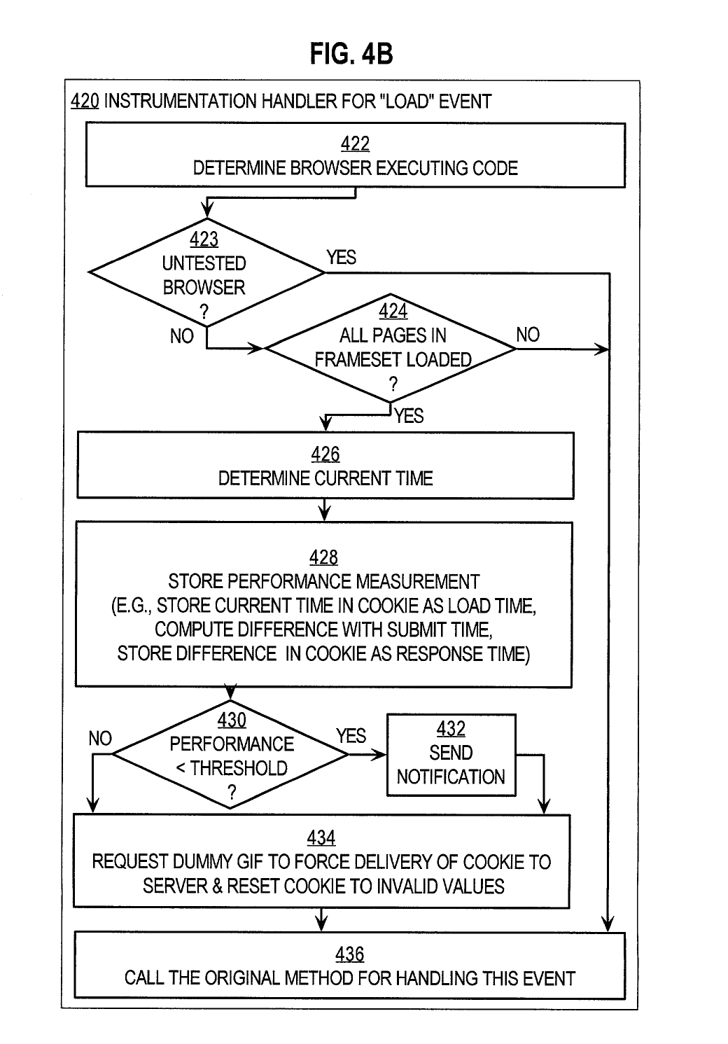

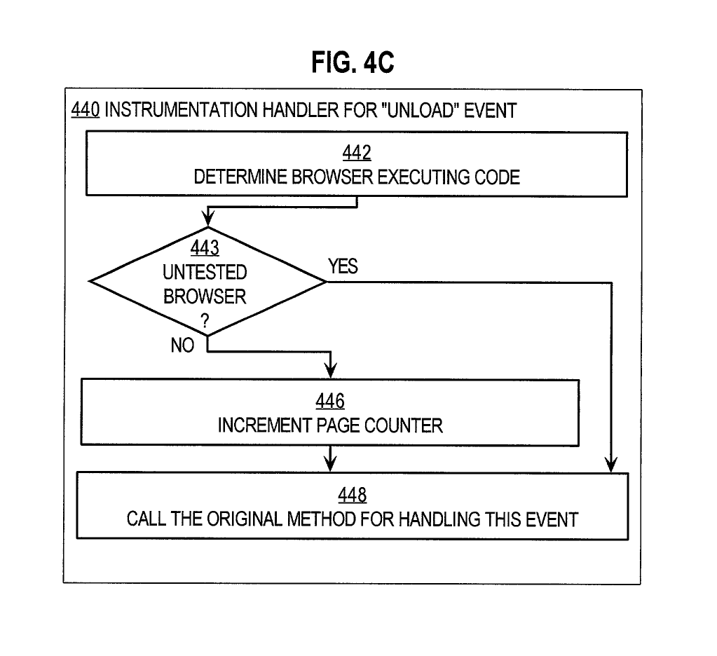

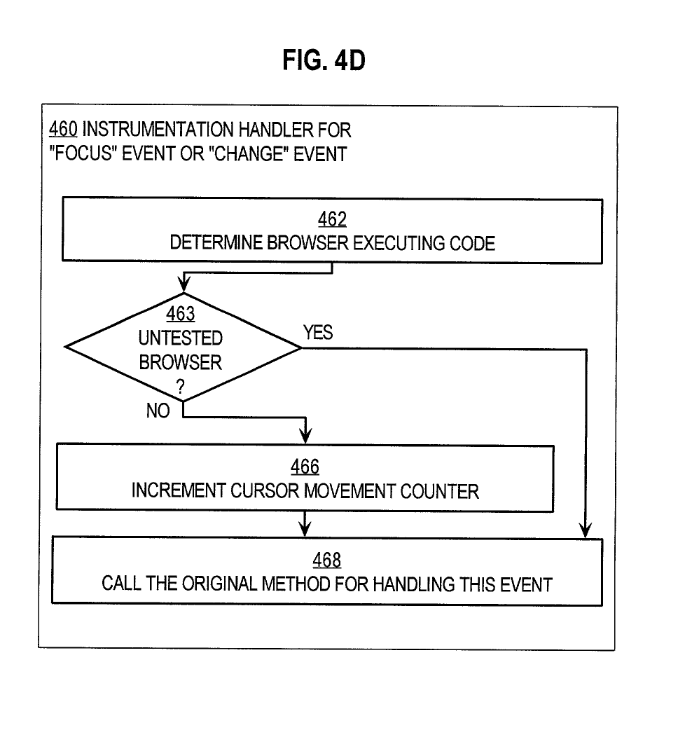

In one embodiment, the performance measurement instrument determines the click to eyeball time of a web page as the difference between a submit time when a user clicks on a link (or SUBMIT button) and a load time when the next frameset is rendered on the web browser. The submit time is determined in a first instrument event handling routine that is called by the web browser when a user clicks on a link or submit button, as described in more detail below with reference to FIG. 4A. The load time is determined in another instrument event handling routine that is called by the web browser when a frameset is rendered, as described in more detail below with respect to FIG. 4B.

In addition to the click-to-eyeball measurement described above, an embodiment will be described in which the performance measurement instrument also determines the number of cursor movements by counting the events associated with making an item on the web page active and changing an item on the web page from the time the web page is loaded until the next web page is requested. A counter is reset to an invalid value in a second instrument event handling routine that is called by the web browser when each frameset is rendered, as described in more detail below with respect to FIG. 4B. The counter value is stored in a third instrument event handling routine that is called by the web browser when a user changes or focuses on a web element, as described in more detail below with reference to FIG. 4D.

According to one embodiment, the submit time and load time and counter value measurements are stored in a preference file also called a cookie. A cookie is a data structure created by a web browser on a client device in response to a script in an HTML page. The web browser automatically sends the cookie with a subsequent request to the same server that provided the HTML page.

### INSTRUMENT EVENT HANDLERS

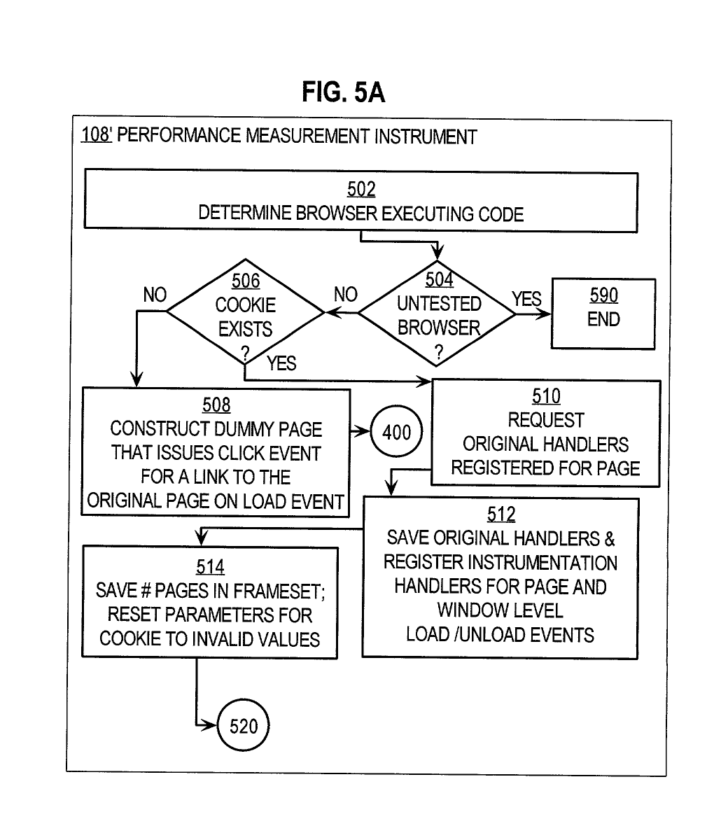

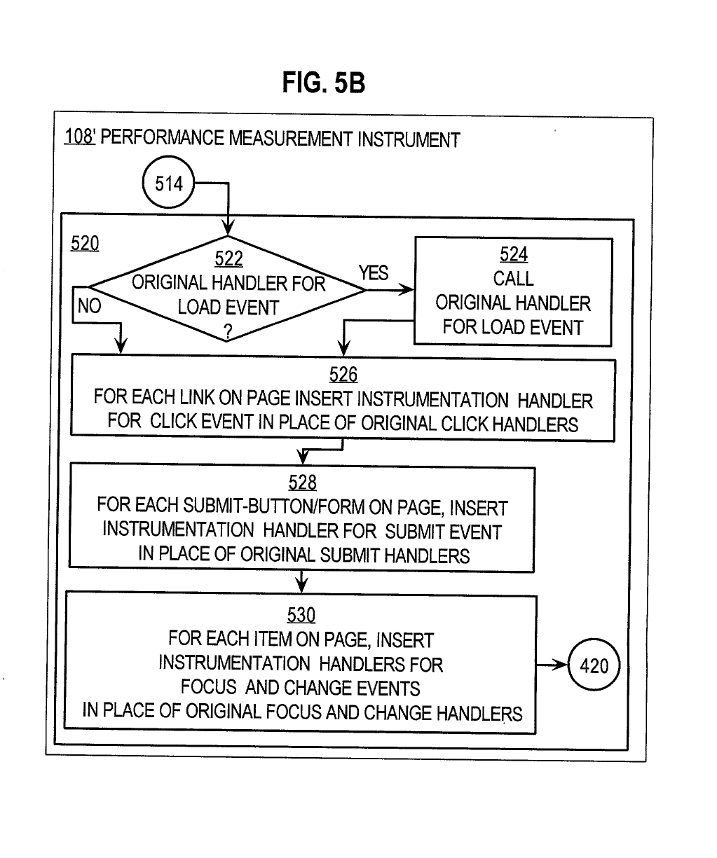

According to one embodiment, a first portion of the performance measurement instrument is executed by the browser immediately upon receipt by the browser of the web page that contains the instrument. When executed, the “execute-on-arrival” code modifies the HTML statements describing each page to associate an “instrument event handler” with at least some of the HTML statements describing the frameset, the web pages, and the web page elements as described in more detail below with reference to FIG. 5A.

A web browser renders a frameset of one or more web pages with web page elements on a display of the client device and responds to actions by a user and by an operating system of the client device that are associated with the web pages or web page elements. The web pages and the web page elements are described with statements in HTML. The web browser response is provided by built-in routines that provide standard behavior. For example, the web browser responds to a user's movement of a cursor by highlighting the web page element in the vicinity of a cursor, and responds to a user's clicking on a link by sending a request to a URL associated with the link in the HTML statements.

The web browser allows the web page provider to provide additional behavior for actions associated with the web page and the web page elements. The browser generates a data structures called an event that describes the action associated with the web page or web page element. The web browser passes the event as a parameter to processes called event handlers that are listed within the HTML statements that define the web page or web page element. The code that describes the event handler is also provided, either directly with the web page or by reference to a file containing the code. If no additional behavior is desired for a web page or web page element, then no event handlers are listed within the HTML statements for that page or element.

According to an embodiment, the instrument includes one or more instrument event handlers that are listed with one or more web pages or web page elements to provide behavior that results in measurements of client-side performance.

The instrumentation event handlers included in the code in the modified item are described next with reference to FIGS. 4A, 4B, 4C and 4D. Following the description of the instrumentation event handlers, a description of the process to associate the instrumentation event handlers with the elements on a web page is described with reference to FIG.s 5A and 5B.

By clicking on a link, or clicking on a submit button of a form, the user initiates a request for a service. Hereinafter a submit event is used to refer to both clicking on a link and clicking on a submit button of a form. A user's perception of the response time of an application on the network begins when the user initiates the request for the service. FIG. 4A is a flowchart illustrating a submit event handler 400 included in modified item sent to a client according to an embodiment. The event handler 400 is associated with submit events; the process of associating web page element with this event handler is described below with reference to FIG. 5B. Thus, when a user of the web browser viewing a downloaded page moves the cursor to a link and clicks, or clicks on a submit button on a form, a routine is called which performs the steps of FIG. 4A. One purpose of this event handler is to record the time when a user perceives a request is made for a service.

In step 402, the web browser type and version that is executing the instrument event handler is determined . The web browser type is determined because the statements that cause the one or more processors on the client device to perform the steps described depend to some extent on the web browser executing the statements. For example, the names of the events generated by the browser when a user manipulates the cursor and device keys may vary among browsers. Also, if a browser is new, the code that implements the instrumentation may not have been tested with the web browser. In such a circumstance, it is safer for the user of the browser if the code is not executed.

In step 403 it is determined whether the browser is one for which the code has been tested. If not, control passes to step 410 to call the original method for handling the click event. Steps 402 and 403 are not performed if the execute-on-arrival code causes the processors of the client device to perform a similar check, as described below with reference to FIG. 5A.

In step 404 the current time is determined. The current time is used to define the time when the request for a service is initiated, as part of the measurement of the response time.

In step 406 performance measures related to submit events are stored in a data structure in memory or in persistent storage. For example, the current time is stored in a cookie as the submit time.

In step 408, ancillary data are also stored in the data structure. The ancillary data are used in subsequent analysis to help diagnose performance problems and design solutions to such problems. For example, the browser type and version are stored as ancillary data. As indicated above, in concert with ancillary data about the browser type and version associated with the response time, the service provider is able to identify item rendering problems that are confined to a particular set of browsers and versions. For another example, the processor and clock speed of the client device are stored as ancillary data.

In step 410 the original event handler for the submit event is called, if any. The browser automatically requests the new page when a user clicks on a link, but not before executing any event handlers associated with the link. Similarly, the browser automatically sends data from a form when the submit button is clicked, but not before executing any event handlers associated with the submit button. Such submit event handlers provide additional functionality to perform when the submit event occurs. The submit event handler 400 replaces any submit handlers originally associated with a link or submit button in the original item produced by the application. Thus, in step 410 the extra functionality provided by the application for the submit event associated with the link or submit button is restored by calling the original event handler. If the application included no submit event handler for the link or submit button, then step 410 is not performed. The web browser then performs the built-in steps, such as automatically requesting the new page associated with the link or automatically sending the data from the form.

A user's perception of the response time of an application on the network concludes when the new item, such as a new frameset, is completely loaded. FIG. 4B is a flowchart illustrating a load event handler 420 included in the modified item sent to a client according to an embodiment. The event handler 420 is associated with frameset load events, also called browser window load events. The association of the window level load event with this handler is described below with reference to FIG. 5A. In embodiments that do not use window load events, a page load event is employed as described below with respect to FIG. 5B. Thus, when a browser window is completely downloaded and rendered on the display of the client device, a routine is called which performs the steps of FIG. 4B. One purpose of this event handler is to record the time when a user perceives that new item is rendered on the display of the client device, thus completing the measurement of response time. In some embodiments, another purpose of this event handler is to respond to unsatisfactory response times in some manner.

Steps 422 and 423 correspond to steps 402 and 403 in FIG. 4A. Steps 422 and 423 skip performing the other steps of the instrumentation event handler when the browser executing the code has not been tested with the code. Steps 422 and 423 are omitted in embodiments in which execute-on-arrival code indicates a similar check, as described below with reference to FIG. 5A.

In step 424 it is determined whether all the pages in the frameset have been loaded. In some embodiments, step 420 is performed by the web browser every time a page is loaded. As shown in FIG. 3, some items cause web browsers to present several pages simultaneously, one in each frame of a frameset. The user's perception of response time is based on loading pages into all the frames of the frameset. Step 424 checks to ensure the page just loaded is the last page in the frameset. For example, in step 424 it is determined whether the number of pages previously loaded, plus the currently loaded page, equals the number of frames in the frameset. The number of frames in the frameset is included in the item sent from the application, and is captured by the processors in the client device based on the execute-on-arrival code, as described below with reference to FIG. 5A. The number of pages previously loaded is maintained in a page counter. As shown in FIG. 4C, the page counter is incremented every time a page is unloaded from an input buffer to make way for the next page and the browser issues an unload event.

If it is determined in step 424 that the page just loaded is not the last in the frameset, then control passes to step 436 to call the original method handler for the load event, if any and if not already called. In another embodiment that does not use window load events, step 436 can be omitted if the original page load event handler is called before performing step 420, such as depicted in FIG. 5B. If step 436 is omitted, or after step 436 is completed, control passes to the web browser built-in methods to proceed with monitoring user manipulation of the cursor and keys.

If it is determined in step 424 that the page just loaded is the last page in the frameset, then control passes to step 426 to determine the current time. The current time is used to define the time when the new frameset is rendered and seen by the user, as part of the measurement of the response time.

In step 428, performance measures related to load events are stored in the data structure in memory or in persistent storage. For example, the current time is stored in the cookie as the load time. As another example, the response time is computed as the difference between the load time and the submit time, and the response time is stored in the cookie.

### CLIENT-SIDE RESPONSES TO PERFORMANCE MEASUREMENTS

In addition to making performance measurements, the instrumentation added to intercepted items may be configured to perform actions based on performance measurements. For example, in step 430, the measured performance is compared to a threshold of minimum performance. If performance is below the threshold of minimum performance, then control passes to step 432 to respond to the degraded performance. For example, if a threshold of minimum performance is associated with a maximum acceptable response time, then response times greater than the maximum response time correspond to performance below the threshold of minimum performance.

If control passes to step 432, then the code causes the web browser to respond to the poor performance. For example, in step 432 the browser sends notification to the user's organization that response times have exceeded the maximum acceptable response times. In some embodiments, notification is sent to a system administrator for the service provider. In some embodiments, a dialog box is presented to the user of the web browser, informing the user that response time is excessive and prompting the user to log a trouble report for the system, or to obtain more resources, such as a larger cache or greater communication bandwidth. In one embodiment, an advertisement, such as an advertisement for a faster Internet access technology, is presented to the user. In some embodiments the notification includes sending a message to another process executing on the network, such as on the server, to automatically perform some acts. Such automatic acts include revising the item produced by the application to be a smaller or simpler item that is communicated and rendered more easily. In some embodiments, the performance measurements in the cookie are sent to the other process during the notification step.

Steps 430 and 432 are omitted in some embodiments in which the response to performance below the threshold is performed by the server based on performance measurements returned to the server, rather than by the client, as described below.

### REPORTING PERFORMANCE MEASUREMENTS

In addition to making performance measurements, the instrumentation that is added to intercepted items may be configured to report the performance measurements to some entity over the network. The entity may be, for example, a web server or application controlled by the service provider of the service whose performance is being measured.

Various techniques may be used to communicate the performance measurements to the service provider. For example, in step 434 a request is made to the server for a dummy image file that contains no data. For example, a request is made for Dummy.gif at the server site. The request causes the web browser to send the cookie with the performance measurements automatically to the server. Because the file Dummy.gif contains no data, nothing is added to the display on the client device and the step is transparent to the user. In another embodiment, step 434 is omitted and the cookie is sent to the server at some later time, such as when the user requests a new page from the server. When step 434 or its equivalent is omitted, the reporting of performance measurements to the server occurs at a later, undetermined time and is said to be lazy reporting.

Control then passes to step 436 to call the original window load event handler. If step 436 is omitted, or after step 436 is completed, control passes to the web browser built-in methods to proceed with monitoring user manipulation of the cursor and keys.

### SERVER-SIDE RESPONSES TO PERFORMANCE MEASUREMENTS

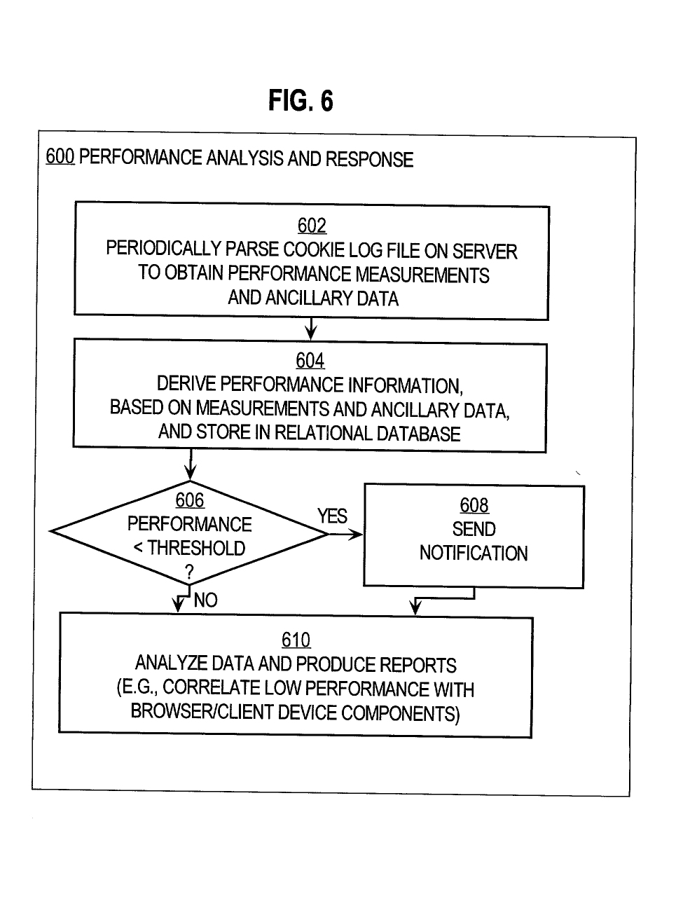

In some embodiments a process executing on a device connected to the network for the benefit of the service provider detects and responds to performance below a threshold of minimum acceptable performance. For example, the performance analysis and response process 194 executing on the server device 102 automatically detects and perform some acts in response to performance below the threshold. The server-side responses are described below with respect to FIG. 6.

### THE UNLOAD EVENT HANDLER

FIG. 4C is a flowchart illustrating an unload event handler 440 included in a modified item sent to a client according to an embodiment. The event handler 440 is associated with unload events, according to a method such as a method described below with reference to FIG. 5A. Thus, when a page is unloaded from an input buffer to make way for the next page, a routine is called which performs the steps of FIG. 4C. A purpose of this event handler is to count the number of pages of a frameset that have actually been downloaded.

Steps 442 and 443 correspond to steps 402 and 403 in FIG. 4A. Steps 442 and 443 skip performing the other steps of the instrumentation event handler when the browser executing the code has not been tested with the code. Steps 442 and 443 are omitted if the execute-on-arrival code indicates a similar check, as described below with reference to FIG. 5A.

In step 446 the page counter is incremented. The counter may reside in memory or on a persistent storage. The counter is retrieved, the value stored in the counter is incremented by one, and the new value is stored. If the counter has been reset, such as when a new frameset is requested, then the counter has an invalid value when it is retrieved, such as zero. When the value of the counter is invalid, step 446 sets the new value for the counter to “1.” In some embodiments, the page counter value is stored in the cookie.

In step 448 the original event handler for unload events, if any, is called. After step 448 is completed, control returns to the web browser built-in methods to monitor user manipulations and the system for generating subsequent events.

### CURSOR EVENT HANDLER

A user's movement of a cursor is related to the effort expended by the user on an item presented on the display of the client device. As the cursor is moved over the browser window it alternately makes active whatever web page elements it passes by. For example, with reference to FIG. 3, as the cursor 361 is moved from the position shown to text area 364, to link 366a, to link 366b, to form 370, to input field 372b, each of these web page elements alternately becomes active in turn, even if the user does not pause or click on any of them. Each time the cursor makes a web page element active, the web browser issues a focus event for the element. A count of those events is a measure of the cursor movement. Also, when a user changes a web page element, such as by selecting a web element and pressing a key, the web browser issues a change event for the element. For example, when a user selects input field 372b by moving the cursor and selecting it, a focus event is issued for the field 372b and a click event is issued for the input field 372b. If the user then types a key, for example, the key for the numeral “7,” a change event is issued for the input field 372b. If the user follows with typing keys for the numerals “321” , then the web browser issues three more change events for the input field 372b. A measure of the total effort expended by the user on the presented item can be obtained by combining the focus and change events. Hereinafter, the focus and change events are collectively referred to as cursor events. The clicks on web page elements that are not links or submit buttons also are included in the cursor events in some embodiments.

FIG. 4D is a flowchart illustrating a cursor event handler 460 included in modified item sent to a client according to an embodiment. The event handler 420 is associated with focus and change events, as described below with reference to FIG. 5B. Thus, when a user moves a cursor over a web page element or changes the values in an input field, a cursor event is issued. One purpose of this event handler is to record the cursor events between the time a page is rendered and the time when a new page is requested.

Steps 462 and 463 correspond to steps 402 and 403 in FIG. 4A. Steps 462 and 463 skip performing the other steps of the instrumentation event handler when the browser executing the code has not been tested with the code. Steps 462 and 463 are omitted if the first portion of the code executed immediately during loading a frameset or page performs a similar check, as in the embodiment described below with reference to FIG. 5A.

In step 466, a cursor movement counter is incremented. The counter may reside in memory or on a persistent storage. In this embodiment, the counter is stored in the cookie.

The counter is retrieved, the value stored in the counter is incremented, and the new value is stored. In some embodiments, the counter is incremented by “1.” In other embodiments, the counter is incremented by “1” for focus events, and by “2” for change events, to reflect a greater effort on the user's part to decide what change to make and to find and press the appropriate key. In yet other embodiments other incremental values are applied. If the counter has been reset, such as when a new frameset is requested, then the counter has an invalid value when it is retrieved, such as the value zero. When the value of the counter is invalid, step 466 sets the new value for the counter to the incremental value, e.g., a “1” for a focus event and a “2” for a change event.

Control then passes to step 468 to call the original cursor event handler, if any. After step 468 is completed, control passes to the web browser built-in methods to proceed with monitoring user manipulation of the cursor and keys.

### EXECUTE-ON-ARRIVAL CODE

FIG.s 4A, 4B, 4C, 4D illustrate event handlers included in the performance measurement code. These steps are executed in response to some action by the web browser and not before the page is loaded. FIG. 5A illustrates steps that are executed immediately as the browser encounters the code in the item, before the web browser issues the load event for the first page of the frameset being downloaded. In one embodiment, the code is inserted at the end of the HTML statements in the original item during step 208 of FIG. 2, and so the code is encountered by the web browser after the original item. In another embodiment, the code is inserted into an HTML statement among the statements in the original item during step 208 of FIG. 2, such as in a header tag, and so is encountered by the web browser before some of the statements in the original item.

FIG. 5A is a first portion of a flowchart illustrating performance measurement code 108′ included in modified item sent to a client according to an embodiment of the predefined performance measurement code 108 depicted in FIG. 1. Performance measurement code 108′ includes the code for the instrumentation event handlers described in FIG. 4A, FIG. 4B, FIG. 4C, FIG. 4D, and associates those instrumentation event handlers with web page elements in the original item.

Steps 502 and 504 correspond to steps 402 and 403 in FIG. 4A. Steps 502 and 504 skip performing the other steps of the performance measurement code when the browser executing the code has not been tested with the code. When the browser is untested with the code 108′, control passes to step 590 to end the method. In embodiments that include steps 502 and 504, the corresponding steps in the event handlers may be omitted. For example steps 402, 403, 422,423, 442, 443, 462 and 463 are omitted in an embodiment including steps 502 and 503.

In step 506, it is determined whether an instrumentation cookie for the application, written by one of the instrumentation event handlers, already resides on the client device. If not, then the frameset being downloaded is the first for the application. Since a response time measurement requires a submit time be stored, a response time cannot be obtained for the first frameset unless some special processing is performed for the first frameset. If it is determined in step 506 that an instrumentation cookie does not exist for the application, then the first frameset for the application is being downloaded, and control passes to step 508 to perform the special processing to capture the response time for the first frameset. Otherwise, control passes to step 510. In some embodiments, steps are not included to detect the first frameset. In these embodiments, step 506 is omitted and control passes unconditionally to step 510 for a tested browser. The special processing represented by step 508 is described in more detail in a later section.

In step 510, the original event handlers associated with the web page elements included in the original item are obtained. Associating an event handler with a web page element is sometimes referred to as registering the event handler with the web page element. The original event handlers can be requested from the web browser in some embodiments, or read directly from the original items. For some browsers, the name of the event handler is dictated by the event and the page element. For example, if an original event handler is provided for a load event associated with the browser window, then the original event handler is named “window.onLoad” for one browser. (A different browser may call the event handler something else, such as frameset.onload.”) To illustrate the method, an example original item is offered that produces the frameset depicted in FIG. 3, and that includes event handlers called window.onLoad for load events involving the frameset, and FormA.onSubmit for submit events involving the form 370 on the page in the first frame of the frameset. No other original event handlers are provided in this example. According to the original item, any clicks on links 366 are handled entirely by the browser by requesting the page at the URL address associated with each link.

In step 512, the original event handlers for window and page level events are saved and replaced by the instrumentation event handlers, and the instrumentation event handlers are registered with the appropriate window and page level elements. For example, the original event handler “window.onLoad” is replaced by the instrumentation event handler 420 shown in FIG. 4B. If the event handler depicted in FIG. 4B is named “F4B₁₃ handler,” then the registration replacement is accomplished with JavaScript statements of the form:

orig₁₃window₁₃load=window.onLoad;

window.onLoad=F4B₁₃handler;.

The name “orig₁₃window₁₃load” is used by the instrumentation handler 420 in step 436. The forms of the call are different in different browsers, so the JavaScript statements to perform step 436 are of the form

if (browserT=“IE”) orig₁₃window₁₃load( );

if (browserT=“NETSCAPE” ) orig₁₃window₁₃load (e);

where “browserT” is a variable indicating the actual browser type detected, for example, in step 502, where IE indicates the INTERNET EXPLORER browser and NETSCAPE indicates the NETSCAPE browser, and where e is an event object passed to the window.onLoad handler by the web browser.

There are no other original event handlers on the page and window level of the example item so no other registration replacements are made in step 512. However, the instrumentation event handlers on the page level are registered with the pages. In the example embodiment, the instrumentation event handler 440 for page unload events depicted in FIG. 4C is used. In the example embodiment, the instrumentation event handler 520 for page load events depicted in FIG. 5B is used. If the instrumentation event handler 520 depicted in FIG. 5B for page load events is named “F5B₁₃handler,” and the instrumentation event handler for page unload events is name “F4C₁₃handler,” then the registration for one embodiment is accomplished with JavaScript statements of the form:

frame1.page.onLoad=F5B₁₃handler;

frame1.page.onUnload=F4C₁₃handler;

frame2.page.onLoad=F5B₁₃handler;

frame2.page.onUnload=F4C₁₃handler;

frame3.page.onLoad=F5B₁₃handler;

frame3.page.onUnload=F4C₁₃handler;

frame4.page.onLoad=F5B₁₃handler;.

frame4.page.onUnload=F4C₁₃handler;

In step 514, the number of frames in the frameset is determined from the information in the original item and saved for use by step 424 in the load event handler 420 illustrated in FIG. 4B. The code also causes the client device to reset to invalid values the parameters in memory corresponding to the parameters stored in the cookie. For example, the variables representing the submit time, the load time, and the number of cursor movements are reset to zero.

This portion of the code is then finished. Subsequently, the first page of the current frameset finishes loading. When the first page finishes loading, the web browser issues a page load event for frame 1. The instrumentation event handler of FIG. 5B was registered for the page load event for frame1, so that event handler is called. Thus control passes to step 520, illustrated in FIG. 5B.

FIG. 5B is a second portion of a flowchart illustrating performance measurement code 108′included in modified item sent to a client according to an embodiment. This code includes an embodiment of a page load event handler 520 that includes the embodiment of the window load event handler 420 described in FIG. 4B. This embodiment is used where a window load event is not employed. In embodiments that employ window load events, control returns to the web browser built-in methods rather than passing to step 420 as shown in FIG. 5B.

In step 522, it is determined whether there is an original event handler for a page load event. If so, control passes to step 524 to call the original handler for the page load event. This is done because some applications insert one or more web page elements that are generated dynamically in a page event handler. These handlers may cause one or more links to be added to the page, for example. By calling the original page load event handler, all the web page elements provided for by the application are on the page by the time control passes to step 526. In the example item, there are no original page load event handlers, and control passes directly to step 526 from step 522.

In step 526, the code causes the web browser to examine each link on the page and insert the instrumentation handler 400, replacing any original click event handlers. In the example item there are five links 366 and no original event handlers for click events. If the links 366a, 366b, 366c, 366d, 366e are identified as LinkA, LinkB, LinkC, LinkD, LinkE, respectively, and the instrumentation event handler 400 is named “F4A₁₃handler,” registration is accomplished with JavaScript statements of the form

LinkA.onClick=F4A₁₃handler;

LinkB.onClick=F4A₁₃handler;

LinkC.onClick=F4A₁₃handler;

LinkD.onClick=F4A₁₃handler;

LinkF.onClick=F4A₁₃handler;

In step 528, the code causes the web browser to examine each form on the page and insert the instrumentation handler 400, replacing any original submit event handlers. In the example item there is one form and it has an original event handler for submit events called “FormA.onSubmit.” The registration replacement is accomplished with JavaScript statements of the form:

orig₁₃form₁₃submit=frame1.FormA.onSubmit

frame1.FormA.onSubmit=F4A₁₃handler. The name “orig₁₃form₁₃submit” is used in a call by the instrument handler in step 410 of the event handler. The forms of the call are different in different browsers, so the JavaScript statements to perform step 410 are of the form

if (browserT=“IE”) orig₁₃form₁₃submit ( );

if (browserT=“NETSCAPE”) orig₁₃form submit (e);

In step 530, the code causes the web browser to examine each element on the page and insert the instrumentation handler 460, replacing any original focus and change event handlers. The handler 460 increments a cursor movement counter, as described above. In the example item there are at least 10 web page elements on the page of the first frame, the test box 364, the five links 366, the form 370 and its elements, the two input fields 372 and the submit button 374, but there are no original event handlers for focus and change events. If the instrumentation event handler 460 is named “F4D₁₃handler,” registration is accomplished with JavaScript statements of the form:

ElementA.onFocus=F4D₁₃handler

ElementA.onChange=F4D₁₃handler

where each of the ten web page elements in turn replaces the element designated “ElementA.”

In some embodiments, control passes to step 420 depicted in FIG, 4B to continue with the steps of that load event handler, as indicated in FIG. 5B. Such an embodiment is useful for browsers that do not distinguish between a load event for a window of one or more pages in different frames and a load event for an individual page.

When all the pages in the different frames of the frameset are loaded, control eventually passes to step 428 to store the response time, or submit and load times, or both, in the cookie. Along the way, control passes several times to the cursor movement event handler 460 depicted in FIG. 4D, which stores the count of cursor movements in the cookie. Eventually the cookie is returned to the server with the measurements that provide response time and cursor movement for each frameset of one or more pages.

### CREATING THE INSTRUMENTATION CODE

In some embodiments, the developer of the application manually inserts the instrument code for measuring client-side performance into the item. However, in the illustrated embodiment, the code included in the modified item 107 is automatically inserted into the item 105 produced by the application 104, if the conditions for modification are satisfied.

It is an advantage for the insert instrument process 106 to automatically perform the desired instrumentation independently and transparently of the application developer, as in the illustrated embodiment. One benefit is that the code may then be inserted, without additional effort, to all the items produced by all the applications on all the servers controlled by the service provider, including those applications already operating and developed before the code 108 was developed.

Another benefit is that the automatic insertion provides a consistent process for measuring performance for all applications. If the developer of each application implemented a separate process to measure performance, such as response time, then the measurements would not necessarily be comparable from one application to another.

### INSTRUMENTATION ALTERNATIVES

In the embodiment illustrated above, the instrumentation code is JAVASCRIPT™ inserted into selected HTML pages sent to a web browser. (Hereinafter JAVASCIPT™ is referred to as JavaScript.) JavaScript is a scripting language interpreted by the web browser that renders the HTML page.

While an embodiment that uses JavaScript is described above, other embodiments may include instructions in other languages that cause the client device to measure performance and act based on the resulting measurements. For example, the code may include another scripting language interpreted by the web browser, such as VisualBasic Script (VBScript). Furthermore, the code may include instructions executed by a process that runs independently of the client process but is launched from the client process, such as plug-in applications launched from the NETSCAPE™ NAVIGATOR™ web browser, ACTIVEX™ applications launched from the MICROSOFT™ INTERNET EXPLORER™ web browser, and JAVA™ applets launched from both of the above web browsers as well as others.

For example, the code may include JAVA™ (hereinafter referred to as Java). Many client processes, such as web browsers, are equipped to receive Java code in an applet. The Java statements in the applet are interpreted by a process called a java virtual machine (JVM). In response to receiving the Java applet, the client process loads the JVM, if it is not already loaded, and uses the JVM to execute the statements in the Java applet. Although more powerful than JavaScript, code written in Java tends to be larger, consuming more communication resources of the client device. Also, loading the JVM to execute the Java applet tends to consume considerable client device memory and processor resources. Thus, embodiments that use Java code to measure client-side performance can more noticeably degrade client-side performance than embodiments that use JavaScript.

The JavaScript of the illustrated embodiment, when executed on a client, provides “click to eyeball” response time values, and total cursor movement, for all HTML items for any client and for any application, without involving the developer of the application, without requiring the user of a client to perform manual steps, and without permanently installing any software on the client devices.

### RESPONSE TIME INSTRUMENTION FOR THE FIRST PAGE

Unless the first page is given special handling, the response time to render the first page is not stored in the cookie. The response time is computed as the time from a submit event to the frameset load event. But the page which requested the first frameset is not instrumented and so did not store the submit time. That page did not even create a cookie for the application. In some circumstances, such as for applications with many pages and only a simple first frameset of pages, this situation is acceptable. The service provider has greater interest in subsequent pages and framesets than the first page. However, for other circumstances, the response time of the first page is highly desirable. For example, the first page may be the most important page to the service provider. Also the first page is sometimes critical in the user's decision whether to continue at the site. Furthermore, statistical sampling of the pages at a website benefits from getting the response time for isolated pages. Several embodiments described next provide a response time for the first page or isolated pages.

In one embodiment, the service provider expects that a given page, say “home.jsp,” is the first page requested by a client process. The service provider renames this first page and generates a place-holding, dummy page with the original name. The dummy page generates a submit event to record a submit time and then requests the renamed first page. For example the first page is renamed “home1.jsp,” and a new page with the original name “home.jsp” is generated that automatically issues a submit event and requests the page “home1.jsp.” The user of the client process requests the page named home.jsp, as before, but now automatically receives the page home1.jsp. This embodiment instruments the dummy page that requests the “home1.jsp” so a response time for rendering “home1.jsp” is provided. However, this embodiment is not useful if the service provider cannot predict the first page that a client process requests.

In a second embodiment, the place-holding dummy page is generated dynamically whenever the first request is received from a client process. The first request is inferred based on an absence of the cookie for the application on the client device. This embodiment is depicted in FIG. 5A. As described above, in step 506, the code executed immediately by the web browser before a page is completed determines whether a cookie exists for the application. If not, then the page being downloaded is the first page requested by the browser, and control passes to step 508. In step 508, the code causes the web browser to construct a dummy page that includes a page load event handler that calls the click on link event handler for a link to the original page. Control then passes to step 400 illustrated in FIG. 4A to create a cookie, record the submit time and request the page. For example, if page P1 from the application is being downloaded when the web browser determines in step 506 that there is no cookie, then the web browser constructs a dummy page. The dummy page has no elements, but includes a load event handler that sets a link to page P1 and calls the click on link event handler 400. After recording the submit time in a cookie in the event handler, the web browser continues with the link processing and requests page P1. This time, when the instrumented page P1 is returned, the included code causes the web browser to detect the cookie in step 506 and proceed with steps 510 and the following steps.

In another embodiment, response time is determined for an isolated page, such as a page chosen for a statistical sample. In this embodiment, two files of predetermined JavaScript code are provided. The first file is inserted into the original item when it is determined in steps 204 and 206 of FIG. 2 that a statistical sample is to be taken. The first file includes code that causes the web browser to capture the submit time and create a special cookie with the submit time and with data indicating the next page is to be instrumented. The second file is inserted into the original item when the special cookie is received with the request for a page. The second file includes code that causes the web browser to capture and record the load time, report the results, and delete the special cookie. In this embodiment, step 204 includes determining whether the special cookie is present, step 206 includes finding the conditions satisfied if the special cookie is present, and step 208 includes inserting the second file instead of the first file if the special cookie is present.

### EXAMPLE OPERATION

Table 1 illustrates the operation of the method by describing the state of the client device at a series of times. The state of the client device is described in Table 1 for each time (“Time” column) by the page presented on the display (“Page” column), whether the page is instrumented with the inserted code (“Instrumented?” column), the web browser event issued at the time (“Event” column), whether a cookie exists that was created by the performance measurement instrument code (“Instrument cookie” column) and the values stored in the cookie for submit time, load time, and cursor movement count, (“Submit Time,” “Load Time,” and “Cursor Count” columns, respectively).

TABLE 1
State of the Client Device Over Time

| | | | | Instru- | Sub- | | |
|---|---|---|---|---|---|---|---|
| | | Instru- | | ment | mit | Load | Cursor |
| Time | Page | mented? | Event | cookie | Time | Time | Count |
| t0 | User's | No | none | NA | NA | NA | NA |
| | Home | | | | | | |
| t1 | User's | No | click on | NA | NA | NA | NA |
| | Home | | link to S1 | | | | |
| t2 | Dummy | Yes | load | NA | NA | NA | NA |
| | | | Dummy | | | | |
| t3 | Dummy | Yes | click on | Yes | t3 | 0 | 0 |
| | | | link to S1 | | | | |
| t4 | S1 | Yes | none | Yes | t3 | 0 | 0 |
| | | | (loading) | | | | |
| t5 | S1.F1 | Yes | load S1.F1 | Yes | t3 | 0 | 0 |
| t6 | S1.F1 | Yes | unload | Yes | t3 | 0 | 0 |
| | | | S1.F1 | | | | |
| t7 | S1.F1,F2 | Yes | load | Yes | t3 | t7 | 0 |
| | | | window | | | | |
| t8 | S1.F1,F2 | Yes | click | Yes | t3 | t7 | 0 |
| | | | Dummy | | | | |
| | | | GIF | | | | |
| t9 | S1.F1,F2 | Yes | focus | Yes | 0 | 0 | 17 |
| | | | *10 + | | | | |
| | | | change*7 | | | | |
| t10 | S1.F1,F2 | Yes | click on | Yes | t10 | 0 | 17 |
| | | | link to S2 | | | | |
| t11 | S2 | Yes | load S2 | Yes | t10 | t11 | 17 |
| t12 | S2 | Yes | click | Yes | t10 | t11 | 17 |
| | | | Dummy | | | | |
| | | | GIF | | | | |

In this example, the server providing the performance measurement instrument includes an application that produces a first frameset S1 having frames F1 and F2, and a second frameset S2 made up of a single page. The page in frame F1 is the same as the page in the first frame depicted in FIG. 3.

At time t0 the web browser presents the user's home page on the display of the client device. The page is not instrumented and the web browser is not configured to measure client side performance. The user has not yet acted and there is no instrument cookie yet created. Therefore, there are no values for submit time, load time or cursor movement count.

At time t1, the user requests a service from the application. The request may be initiated in any way known in the art. For example, the user may type the URL for the application in an address bar of the web browser; or the user may click on a link stored as a bookmark in the browser based on some prior use of the application; or the user may click on a link on the user's home page. In any case, the web browser issues an event equivalent to a click on a link to the application that provides frameset S1. Because the user's home page is not instrumented, the web browser does not create a cookie or store a submit time. A request is sent to the server for the application.

In response to the request, the application generates the item for frameset S1 and the server modifies the item by inserting the predefined JavaScript described above with respect to the instructions executed during loading illustrated in FIG. 5A and the instrumentation event handlers illustrated in FIG. 5B, FIG. 4A, FIG. 4B, FIG. 4C and FIG. 4D. While loading the modified item, the web browser begins to execute the code for performing the steps illustrated in FIG. 5A. In step 506, the web browser determines that the instrument cookie does not yet exist so control passes to step 508. The code represented by step 508 causes the web browser to construct a dummy page, herein named “Dummy,” with a page load event handler that clicks on a link to the application and with the instrumentation handler 400 of FIG. 4A for click on link events.

At time t2 the blank Dummy page is loaded and presented on the display of the client device. The web browser issues a page load event. No instrument cookie has yet been created and no values have been set for the submit time, load time or cursor count.

In response to the load page event, at time t3 (probably microseconds after time t2), the web browser issues a click on link event and executes the instrumentation event handler 400 for click on link. As shown in FIG. 4A, this instrumentation event handler 400 determines the current time t3 in step 404 and, in step 406 stores that time in a cookie as the submit time. The values of the load time and the cursor count, having invalid values of zero, are also stored in the cookie during step 406. Table 1 shows that at time t3, a cookie now exists with the value t3 as the submit time. In step 408 ancillary data is stored in the cookie, such as the type and version of the web browser executing on the client device. In this example, there is no original event handler for the click on link event and so step 410 performs no action. Control then returns to the web browser methods for requesting service from the application on the server. The cookie is automatically sent to the server by the web browser with the request.

In response to the request, the application again generates the item for frameset S1 and the server again modifies the item by inserting the predefined JavaScript. While loading the modified item, at time t4 in Table 1, the web browser again begins to execute the code for performing the steps illustrated in FIG. 5A. In step 506, the web browser determines that the instrument cookie does now exist, so control passes to steps 510 through 514. The code represented by steps 510 and 512 causes the web browser to find any original event handlers for windows and page level events and to replace those with the instrumentation event handlers for window and page level events. In this example, there are no original event handlers for such events. The windows.onLoad event handler is set to instrumentation handler 420 illustrated in FIG. 4B; the page.onload event handler is set to instrumentation handler 520 illustrated in FIG. 5B; and the page.onUnload event handler is set to instrumentation handler 440 illustrated in FIG. 4C. In step 514 the number of pages in the frameset is saved. According to the information in example frameset S1, there are two pages in the frameset; so the value 2 is saved in a variable named, for example, Npages, as the number of pages in the frameset. Other parameters used for creating and updating the cookie are set to invalid values. For example, a page counter, the cursor movement counter, the submit time, and the load time are set to zero. However, the cookie is not updated at this time.

At time t5, the page F1 in the first frame of the frameset S1 is loaded, indicated by S1.F1 in the “Page” column of Table 1. The web browser issues a page load event for page S1.F1 and the instrumentation event handler 520 for page load events illustrated in FIG. 5B is executed. In step 522 it is determined that there is no original page event handler and control passes to steps 526, 528 and 530 to register event handlers for click on link, submit, focus and change events for various web page elements on the page (as described above for the page depicted in the first frame in FIG. 3). In this example, the web browser is able to issue a windows level load event, so control does not pass to step 420 until the windows load event is issued by the web browser. Instead, control passes to the web browser's built-in methods. No change is made to the cookie at this time.

If the web browser does not issue a window level load event, then control passes to step 420, which, in step 424, determines that all pages in the frameset are not yet loaded, then returns control to the web browser's built-in methods.

At time t6, the web browser issues an unload event for the page S1.F1 and invokes the instrumentation handler 440 for page unload events illustrated in FIG. 4C. In step 446 a page counter is incremented. Since the page counter has an invalid value when first called, the page counter is set to a value of one. No change is made to the cookie.

At time t7, the page F2 in the second frame of the frameset S1 is loaded, indicated by S1.F1, F2 in the “Page” column of Table 1. The web browser issues a page load event for page S1.F2 and instrumentation handler 520 for page load events illustrated in FIG. 5B is executed. In step 522 it is determined that there is no original page event handler and control passes to steps 526, 528 and 530 to register event handlers for click on link, submit, focus and change events for various web page elements on the page. In this example, the web browser also issues a windows level load event so control does pass to step 420. If the web browser does not issue a window level load event, then control passes to step 420 from within the page load event handler 520.

In step 424 it is determined that all pages in the frameset are loaded because the page counter (which does not include the current page), plus one for the current page, is equal to the number of pages in the frameset, saved in the variable NPages. In step 426 the current time is determined to be t7. In step 428 the cookie is updated with t7 as the load time. Table 1 shows the cookie contains a submit time of t3, a load time of t7 and a cursor count of 0 at time t7. In some embodiments the difference t7-t3 is also stored as the response time. In this example, steps 430 and 432 are not included and control passes directly to step 434.

At time t8, in step 434 a request for an image file called Dummy.gif is generated and sent to the server. The web browser automatically includes the cookie with the request, so the values of the submit time, load time and cursor count at time t8 are sent to the server and stored in the server's log of cookies. The Dummy.gif file contains no data, so no change is shown on the display device. The values in the cookie are then reset to zero. In embodiments with lazy reporting, step 434 is omitted and the cookie is reported when the browser next requests a page from the application on the server.

There are no original event handlers for the load window event in this example, so step 436 performs no action and control next passes to the web browser's built-in methods. The web browser then monitors user manipulations of web page elements in the frameset. In this example, the user moves the cursor over each element on a page in the first frame that looks like the page depicted in the first frame in FIG. 3. As the user moves the cursor over each page element, the web browser issues a focus event and calls the instrumentation handler 460 for cursor events illustrated in FIG. 4D, which, in step 466, increments the cursor movement counter stored in the cookie. The user also enters three characters of data in input field 372a and four characters of data input field 372b. As the user enters each character, the web browser issues a change event and calls the instrumentation handler 460 for cursor events illustrated in FIG. 4D, which, in step 466, increments the cursor movement counter stored in the cookie. In this example each change is treated the same as each focus and recorded as an increment of 1.

At time t9 the ten focus events and seven change events have occurred as indicated in the “Event” column, yielding 17 cursor movements. The cookie contains the invalid values (0, 0) for submit time and load time placed there during step 434, and the value 17 for the cursor count. In an embodiment with lazy reporting, which skips step 434, the cookie contains values of t3, t7 and 17 for the submit time, load time, and cursor count, respectively.

At time t10 the user clicks on the “NEXT” button 366e shown in FIG. 3 on the page F1 in the first frame of the first frameset S1. The web browser issues a click event for the link and invokes the instrumentation handler 400 for click on link events illustrated in FIG. 4A. As shown in FIG. 4A, this instrumentation event handler 400 determines the current time t10 in step 404 and, in step 406 stores that time in a cookie as the submit time. The values of the load time and the cursor count, having values of zero and 17, respectively, are also stored in the cookie, as shown in Table 1. In step 408 ancillary data, if any, is stored in the cookie. Examples of ancillary information that is stored in cookies in some embodiments include log-in information such as user identification, and encrypted passwords that persist from one session to another. In some embodiments, the ancillary information includes information indicating the type of transaction, such as a change order, a refund, and a transfer of funds from one account to another. In some embodiments, the ancillary information is not stored again if already in the cookie. In embodiments with lazy reporting, the values in the cookie are t3, t7, and 17, which have not yet been reported to the server; so, the old submit time t3 is moved to a separate variable and stored in the cookie before the new submit time t10 is stored.

In this example, there is no original event handler for the click on link event and so step 410 performs no action. Control then returns to the web browser methods for requesting the next frameset from the application on the server. The cookie is automatically sent to the server by the web browser with the request. This cookie contains the new submit time and the cursor count for the previous page. In embodiments with lazy reporting, the cookie sent with the request contains the submit time, load time and cursor count for the previous page as well as the submit time for the current page, respectively, t3, t7, 17 and t10.

In response to the request, the application generates the item for frameset S2 and the server again modifies the item by inserting the predefined JavaScript. While loading the modified item, the web browser begins to execute the code for performing the steps illustrated in FIG. 5A. In step 506, the web browser determines that the instrument cookie exists, so control passes to steps 510 through 514. The code represented by steps 510 and 512 causes the web browser to find any original event handlers for windows and page level events and to replace those with the instrumentation event handlers for window and page level events. In this example, there are no original event handlers for such events. The windows.onLoad event handler is set to instrumentation handler 420 illustrated in FIG. 4B; the page.onLoad event handler is set to instrumentation handler 520 illustrated in FIG. 5B; and the page.onUnload event handler is set to instrumentation handler 440 illustrated in FIG. 4C. In step 514 the number of pages in the frameset is saved. According to the information in example frameset S2, there is one page in the frameset; so the value 1 is saved in the variable NPages. Other parameters used for creating and updating the cookie are set to invalid values. For example, a page counter, the cursor movement counter, the submit time, and the load time are set to zero, but the cookie is not updated.

At time t11, the only page in the second frameset S2 is loaded, as indicated by S2 in the “Page” column of Table 1. The web browser issues a page load event for page S2 and the instrumentation handler 520 for page load events illustrated in FIG. 5B is executed. In step 522 it is determined that there is no original page event handler and control passes to steps 526, 528 and 530 to register event handlers for click on link, submit, focus and change events for various web page elements on the page. In this example, the web browser also issues a windows level load event so control does pass to step 420.

In step 424 it is determined that all pages in the frameset are loaded because the page counter (which does not include the current page), plus one for the current page, is equal to 1, the number of pages in the frameset, saved in the variable NPages. In step 426 the current time is determined to be t11. In step 428 the cookie is updated with t11 as the load time. Table 1 shows the cookie contains a submit time of t10, a load time of t11 and a cursor count of 17 at time t11. In some embodiments the cursor count is also updated, which resets the value to 0 in the cookie. In some embodiments the difference t7-t3 is also stored as the response time. In this example, steps 430 and 432 are not included and control passes directly to step 434.

At time t12, step 434 requests an image file called Dummy.gif from the server. The web browser automatically includes the cookie with the request, so the values of the submit time, load time and cursor count at time t12 are sent to the server and stored in the server's log of cookies. The Dummy.gif file contains no data, so no change is shown on the display device. The values in the cookie are then reset to zero. In embodiments with lazy reporting, step 434 is omitted and the cookie is reported when the browser next requests a page from the application on the server.

Thus, the example JavaScript code inserted by a server into HTML framesets produced by an application on the server forms modified items which, when downloaded by a web browser on a client device, causes the web browser to record client-side performance measurements indicating response time and cursor movement and report those measurements to the server.

### EXAMPLE SERVER-SIDE RESPONSE TO CLIENT-SIDE PERFORMANCE

In some embodiments a process executing on a device connected to the network for the benefit of the service provider responds to performance. For example, the performance analysis and response process 194 executing on the server device 102 automatically detects performance below a threshold of minimum acceptable performance and then performs some acts in response to performance below the threshold.

In some embodiments the automatic acts include sending notification based on the performance measurements. Notification includes sending a page or placing a telephone call to a system administrator for the service provider that performance has degraded for a particular user or organization of users. In some embodiments the notification includes sending a message to another process executing on the network, such as on the server device, to automatically perform some acts.

In some embodiments, the automatic acts include determining a difference between the response time perceived by the user and the time spent on the server side between receiving a request and sending an item in response. If the difference is small, the performance problem is isolated to the server side. If the difference is large, the problem is isolated to the client and network side.

In some embodiments, the automatic acts include revising the item produced by the application to be smaller or simpler so that the item may be communicated and rendered more easily. Revising the item produced is especially useful when the problem has been isolated to the server side.

In some embodiments, response time is correlated with browser type and version or operating system type and version or both to determine whether a trend can be detected indicating some browser versions experience significantly worse performance than others. The Web server logs browser and operating system type and version from a user agent field provided with Web requests for service. In some embodiments, correlations are performed to detect trends with client device components. Correlating response times with browsers or client device components or both is especially useful when the problem has been isolated to the client side.

FIG. 6 is a flowchart illustrating an example performance analysis and response method 600 for operating on client-side performance measurements reported to the server according to an embodiment. In some embodiments the method 600 is executed on the server. In other embodiments, the method 600 is executed on another device connected to the server through the network.

In step 602, a cookie log automatically formed on the server is parsed to obtain performance measurements and ancillary data for analysis. In step 604 performance information is derived based on the measurements and ancillary data and stored in a relational database. For example, response time is derived from submit time and load time and stored in a database table with a reference to the frameset, the time and date of the measurement, the browser type and version, and the cursor movement count for the frameset. The information placed together in the relational database may be found dispersed through the log file. For example, with the immediate reporting provided by step 434, the cursor count for the first frameset appears in the cookie log with the submit time for the second frameset.

In step 606 it is determined whether the performance is below some threshold of minimum performance. If performance is below the threshold of minimum performance, then control passes to step 608 to respond to the degraded performance. For example, if a threshold of minimum performance is associated with a maximum acceptable response time, then response times greater than the maximum response time correspond to performance below the threshold of minimum performance. For example, if a threshold of minimum performance is that 90% of users should experience response times less than 10 seconds, then detecting 85% of users experiencing response times less than 10 seconds corresponds to performance below the threshold of minimum performance.

In step 608, a response is generated to performance below the threshold. For example, step 608 sends notification. Notification includes sending a page or placing a telephone call to a system administrator for the service provider that performance has degraded for a particular user or organization of users. In some embodiments the notification includes sending a message to another process executing on the network, such as on the server, to automatically perform some acts.

Some responses include revising the item produced by the application to produce a smaller or simpler item that is communicated and rendered more easily. Some responses include determining a difference between the response time perceived by the user and the time spent on the server side between receiving a request and sending an item in response. If the difference is small, the performance problem is isolated to the server side. If the difference is large, the problem is isolated to the client and network side.

In step 610, the data in the relational database is analyzed and reports are produced. For example, response time is correlated with browser type and version to determine whether a trend can be detected indicating some browser versions experience significantly worse performance than others. For another example, correlations are performed to detect trends with client device components.

These techniques allow the service provider to obtain measurements of actual performance experienced by the real users for performing analyses, such as automatically diagnosing the cause of unfavorable performance by correlating performance problems with particular components of the client process or client device.

### HARDWARE OVERVIEW

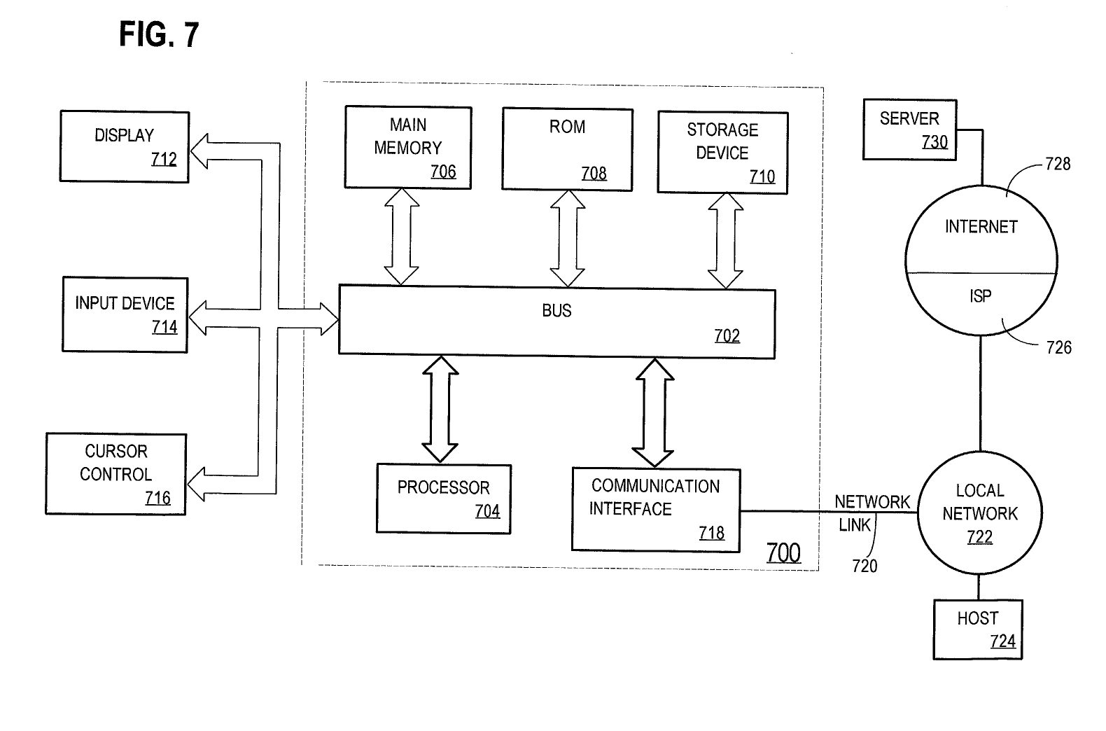

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for measuring client-side performance, the method comprising the steps of:
intercepting an item that is to be sent to a client process prior to the arrival of the item at the client process;
modifying the item to produce a modified item that includes code which causes one or more processors on the client device to perform the steps of:
measuring performance related to a service associated with the item, and
performing one or more acts based on a measurement resulting from said step of measuring performance; and
sending the modified item to the client process.

2. The method of claim 1, wherein said step of modifying the item is performed transparently relative to an application that generates the item for the service.

3. The method of claim 1, wherein said steps of measuring performance and performing one or more acts based on the measurement are performed transparently relative to a user of the client process.

4. The method of claim 1, said step of performing one or more acts based on the measurement further comprising the step of sending data indicating the measurement to an entity over a network.

5. The method of claim 4, said step of sending the data to an entity further comprising storing the data in a data structure that is automatically sent to a server device associated with said service in response to a later request from the client process for said service.

6. The method of claim 5, wherein:
the client process is a web browser; and
the data structure is a cookie stored on the client device by the web browser.

7. The method of claim 4, wherein:
the step of modifying the item includes adding code to the item that causes the client process to issue a request; and
said step of sending data to an entity further comprises sending the request including the data to a server device.

8. The method of claim 7, wherein the request is for a particular file and in response to the request for the particular file no change is made by the client process to a page already rendered on a display of the client device.

9. The method of claim 4, further comprising storing the data indicating the measurement in a log file on a server device.

10. The method of claim 4, further comprising storing the data indicating the measurement in a database of the entity on the network.

11. The method of claim 1, further comprising the steps of:
receiving over a network data indicating the measurement from the client process; and
performing one or more acts based on the data indicating the measurement.

12. The method of claim 11, said step of performing one or more acts based on the data indicating the measurement further comprising:
determining whether the data indicates performance has fallen below a threshold; and
if the data indicates performance has fallen below the threshold, then sending a notification message.

13. The method of claim 1, said step of performing one or more acts based on the measurement further comprising:
determining whether the measurement indicates performance has fallen below a threshold; and
if the measurement indicates performance has fallen below the threshold, then sending a notification message.

14. The method of claim 13, said step of sending a notification message comprising sending the notification message to an administrator for a server device associated with said service.

15. The method of claim 13, said step of sending a notification message comprising sending the notification message to a user of the client process.

16. The method of claim 1, wherein the measurement is a client response time between a first time when a user of the client process selects an item on a first web page rendered on a display of the client device and a second time when a second web page is fully rendered on the display of the client device.

17. The method of claim 1, wherein:
the code further causes the one or more processors on the client device to perform the step of collecting ancillary information relating to one or more components of the client process that participate in obtaining the service from the application; and
said step of performing one or more acts based on the measurement includes correlating the measurement with the ancillary information.

18. The method of claim 1, after said step of intercepting the item and before said step of modifying the item, further comprising the steps of:
determining a type associated with the item produced by the application; and
determining whether to perform said step of modifying the item based on the type of the item.

19. The method of claim 1, after said step of intercepting the item and before said step of modifying the item, further comprising the steps of:
determining a unique reference associated with the item produced by the application; and
determining whether to perform said step of modifying the item based on whether the unique reference matches a particular reference.

20. The method of claim 1, after said step of intercepting the item and before said step of modifying the item, further comprising the steps of:
determining a percentage of modified items relative to items to be sent to the client process; and
determining whether to perform said step of modifying the item based on whether the percentage is below a particular percentage.

21. The method of claim 1, wherein:
the item to be sent to the client process is stored in a cache before the item is sent to the client process;
said step of intercepting the item comprises accessing the item in the cache; and
said step of sending the modified item to the client process comprises replacing the item in the cache with the modified item.

22. The method of claim 21, wherein the cache is on a server device associated with said service.

23. The method of claim 21, wherein the cache is on a proxy server for the client process.

24. The method of claim 1, wherein:
the item includes hypertext markup language (HTML) statements; and
the client process is a web browser.

25. The method of claim 24, wherein:
the web browser is configured to run javascript; and
the code comprises javascript statements.

26. The method of claim 1, wherein the code conforms to a scripting language.

27. The method of claim 1, wherein the code comprises a Java applet.

28. The method of claim 1, wherein the code comprises an ActiveX module.

29. The method of claim 1, said step of modifying the item further comprising appending the code to the end of the item.

30. The method of claim 1, wherein:
the item includes markup language statements; and
said step of modifying the item further comprises inserting the code at a particular statement of the markup language statements.

31. The method of claim 1, wherein:
the code includes at least one of first code added to a first item and second code added to a second item; and
said measuring performance comprises starting a time measurement based on the first code and ending a time measurement based on the second code.

32. The method of claim 31, wherein:
the first code is executed in response to a user of the client process clicking on a control included in the first item; and
the second code is executed in response to fully loading the second item.

33. The method of claim 1, wherein the code includes first code executed upon arrival of the first code at the client process and second code executed in response to a data structure generated by the client process after arrival of the first code.

34. The method of claim 33, wherein the data structure describes an event at the client device.

35. The method of claim 34, wherein the event is a message received from an operating system executing on the client device.

36. The method of claim 34, wherein the event is a manipulation of a control of the client device by a user.

37. The method of claim 33, wherein the second code causes the one or more processors to perform the step of measuring performance.

38. The method of claim 33, wherein the second code causes the one or more processors to record a current time.

39. The method of claim 33, wherein:
the item to be sent to the client process includes third code to be executed in response to the data structure generated by the client process; and
the first code causes the one or more processors to perform the step of replacing the third with the second code.

40. The method of claim 1, wherein the code includes first code executed in response to a data structure describing a first event generated by the client process and second code executed in response to a data structure describing a second event generated by the client process.

41. The method of claim 40, wherein:
the item to be sent to the client process includes third code to be executed in response to the data structure describing the second event by the client process; and
the first code causes the one or more processors to perform the step of replacing the third with the second code.

42. A computer-readable medium carrying one or more sequences of instructions for measuring client-side performance, wherein execution of the one or more sequences of instructions by one or more processors causes the one or more processors to perform the steps of:
intercepting an item that is to be sent to a client process prior to the arrival of the item at the client process;
modifying the item to produce a modified item that includes code which causes one or more processors on the client device to perform the steps of:
measuring performance related to a service associated with the item, and
performing one or more acts based on a measurement resulting from said step of measuring performance; and
sending the modified item to the client process.

43. The computer-readable medium of claim 42, wherein said step of modifying the item is performed transparently relative to an application that generates the item for the service.

44. The computer-readable medium of claim 42, wherein said steps of measuring performance and performing one or more acts based on the measurement are performed transparently relative to a user of the client process.

45. The computer-readable medium of claim 42, said step of performing one or more acts based on the measurement further comprising the step of sending data indicating the measurement to an entity over a network.

46. The computer-readable medium of claim 45, said step of sending the data to an entity further comprising storing the data in a data structure that is automatically sent to a server device associated with said service in response to a later request from the client process for said service.

47. The computer-readable medium of claim 46, wherein:
the client process is a web browser; and
the data structure is a cookie stored on the client device by the web browser.

48. The computer-readable medium of claim 45, wherein:
the step of modifying the item includes adding code to the item that causes the client process to issue a request; and
said step of sending data to an entity further comprises sending the request including the data to a server device.

49. The computer-readable medium of claim 48, wherein the request is for a particular file and in response to the request for the particular file no change is made by the client process to a page already rendered on a display of the client device.

50. The computer-readable medium of claim 45, wherein execution of the one or more sequences of instructions by the one or more processors further causes the one or more processors to perform the step of storing the data indicating the measurement in a log file on a server device.

51. The computer-readable medium of claim 45, wherein execution of the one or more sequences of instructions by the one or more processors further causes the one or more processors to perform the step of storing the data indicating the measurement in a database of the entity on the network.

52. The computer-readable medium of claim 42, wherein execution of the one or more sequences of instructions by the one or more processors further causes the one or more processors to perform the steps of:
receiving over a network data indicating the measurement from the client process; and
performing one or more acts based on the data indicating the measurement.

53. The computer-readable medium of claim 52, said step of performing one or more acts based on the data indicating the measurement further comprising:
determining whether the data indicates performance has fallen below a threshold; and
if the data indicates performance has fallen below the threshold, then sending a notification message.

54. The computer-readable medium of claim 42, said step of performing one or more acts based on the measurement further comprising:
determining whether the measurement indicates performance has fallen below a threshold; and
if the measurement indicates performance has fallen below the threshold, then sending a notification message.

55. The computer-readable medium of claim 54, said step of sending a notification message comprising sending the notification message to an administrator for a server device associated with said service.

56. The computer-readable medium of claim 54, said step of sending a notification message comprising sending the notification message to a user of the client process.

57. The computer-readable medium of claim 42, wherein the measurement is a client response time between a first time when a user of the client process selects an item on a first web page rendered on a display of the client device and a second time when a second web page is fully rendered on the display of the client device.

58. The computer-readable medium of claim 42, wherein:
the code further causes the one or more processors on the client device to perform the step of collecting ancillary information relating to one or more components of the client process that participate in obtaining the service from the application; and
said step of performing one or more acts based on the measurement includes correlating the measurement with the ancillary information.

59. The computer-readable medium of claim 42, wherein execution of the one or more sequences of instructions by the one or more processors further causes the one or more processors, after said step of intercepting the item and before said step of modifying the item, to perform the steps of:
determining a type associated with the item produced by the application; and
determining whether to perform said step of modifying the item based on the type of the item.

60. The computer-readable medium of claim 42, wherein execution of the one or more sequences of instructions by the one or more processors further causes the one or more processors, after said step of intercepting the item and before said step of modifying the item, to perform the steps of:
determining a unique reference associated with the item produced by the application; and
determining whether to perform said step of modifying the item based on whether the unique reference matches a particular reference.

61. The computer-readable medium of claim 42, wherein execution of the one or more sequences of instructions by the one or more processors further causes the one or more processors, after said step of intercepting the item and before said step of modifying the item, to perform the steps of:
determining a percentage of modified items relative to items to be sent to the client process; and
determining whether to perform said step of modifing the item based on whether the percentage is below a particular percentage.

62. The computer-readable medium of claim 42, wherein:
the item to be sent to the client process is stored in a cache before the item is sent to the client process;
said step of intercepting the item comprises accessing the item in the cache; and
said step of sending the modified item to the client process comprises replacing the item in the cache with the modified item.

63. The computer-readable medium of claim 62, wherein the cache is on a server device associated with said service.

64. The computer-readable medium of claim 62, wherein the cache is on a proxy server for the client process.

65. The computer-readable medium of claim 42, wherein:
the item includes hypertext markup language (HTML) statements; and
the client process is a web browser.

66. The computer-readable medium of claim 65, wherein:
the web browser is configured to run javascript; and
the code comprises javascript statements.

67. The computer-readable medium of claim 42, wherein the code conforms to a scripting language.

68. The computer-readable medium of claim 42, wherein the code comprises a Java applet.

69. The computer-readable medium of claim 42, wherein the code comprises an ActiveX module.

70. The computer-readable medium of claim 42, said step of modifying the item further comprising appending the code to the end of the item.

71. The computer-readable medium of claim 42, wherein:
the item includes markup language statements; and
said step of modifying the item further comprises inserting the code at a particular statement of the markup language statements.

72. The computer-readable medium of claim 42, wherein:
the code includes at least one of first code added to a first item and second code added to a second item; and
said measuring performance comprises starting a time measurement based on the first code and ending a time measurement based on the second code.

73. The computer-readable medium of claim 72, wherein:
the first code is executed in response to a user of the client process clicking on a control included in the first item; and
the second code is executed in response to fully loading the second item.

74. The computer-readable medium of claim 42, wherein the code includes first code executed upon arrival of the first code at the client process and second code executed in response to a data structure generated by the client process after arrival of the first code.

75. The computer-readable medium of claim 74, wherein the data structure describes an event at the client device.

76. The computer-readable medium of claim 75, wherein the event is a message received from an operating system executing on the client device.

77. The computer-readable medium of claim 75, wherein the event is a manipulation of a control of the client device by a user.

78. The computer-readable medium of claim 74, wherein the second code causes the one or more processors to perform the step of measuring performance.

79. The computer-readable medium of claim 74, wherein the second code causes the one or more processors to record a current time.

80. The computer-readable medium of claim 74, wherein:
the item to be sent to the client process includes third code to be executed in response to the data structure generated by the client process; and
the first code causes the one or more processors to perform the step of replacing the third with the second code.

81. The computer-readable medium of claim 42, wherein the code includes first code executed in response to a data structure describing a first event generated by the client process and second code executed in response to a data structure describing a second event generated by the client process.

82. The computer-readable medium of claim 81, wherein:
the item to be sent to the client process includes third code to be executed in response to the data structure describing the second event by the client process; and
the first code causes the one or more processors to perform the step of replacing the third with the second code.

83. A method for responding to client-side performance on a network connecting a client device executing a client process to a server device configured to execute an application to provide a service, the method comprising the steps of:
intercepting an item produced by the application;
modifying the item transparently relative to the application to produce a modified item including code which causes one or more processors on the client device to perform the steps of,
measuring performance related to the service provided by the application, and
based on a measurement resulting from said step of measuring performance, sending data indicating the measurement to the server device;
sending the modified item to the client process;
receiving the data indicating the measurement;
storing the data indicating the measurement in a database; and
based on the data indicating the measurement,
determining whether the data indicates performance has fallen below a threshold, and
if the data indicates performance has fallen below the threshold, then sending a notification message.

84. A computer-readable medium carrying:
data indicating elements for presentation on a display of a device having one or more processors by a client process executing on the one or more processors;
a first sequence of instructions executed upon receipt at the device; and
a second sequence of instructions invoked after arrival of the first sequence of instructions by the client process,
wherein,
the second sequence of instructions causes the one or more processors to perform the steps of:
measuring performance related to presenting the elements on the display; and
performing one or more acts based on a measurement resulting from said step of measuring performance; and
the first sequence of instructions causes the client process to associate the second sequence of instructions with an element indicated by the data.
